(19) United States
(12) Patent Application Publication
(10) Pub. No.: US 2023/0218932 A1
(43) Pub. Date: Jul. 13, 2023

(54) Elbow Sleeve

(71) Applicant: Cynthia Robertson, Memphis, TN (US)

(72) Inventor: Cynthia Robertson, Memphis, TN (US)

(21) Appl. No.: 18/095,312

(22) Filed: Jan. 10, 2023

Related U.S. Application Data
(60) Provisional application No. 63/298,064, filed on Jan. 10, 2022.

(51) Int. Cl. A62B 23/02

(52) U.S. Cl. CPC A62B 23/025; A41D 13/113

(57) ABSTRACT

This invention relates to filters, filter assemblies, face masks, and face mask assemblies, and methods of making same. In various aspects, the disclosed filters, filter assemblies, face masks, and face mask assemblies can be useful in, for example, preventing the transmission of air contaminants to or from a wearer. This abstract is intended as a scanning tool for purposes of searching in the particular art and is not intended to be limiting of the present invention.

### CROSS-REFERENCE TO RELATED APPLICATIONS

This Application claims the benefit of U.S. Application No. 63/298,064, filed on Jan. 10, 2022, the contents of which are incorporated herein by reference in their entirety.

### FIELD

This application relates generally to devices and methods for refining air contaminants. More specifically, devices and methods are provided for preventing the transmission of air contaminants to or from a wearer.

### BACKGROUND

Face masks, such as surgical face masks, procedure masks, dental masks, and isolation masks, are worn by individuals to protect themselves and those around them from exposure to undesirable air contaminants. When worn properly, these masks can be very effective at preventing bacteria and viral particles from spreading to others, and also at preventing the wearer from contracting a diseases from someone else. In the event that the wearer has to sneeze or cough, however, they are faced with a dilemma; namely, whether to remove the mask and risk exposure and danger to others, or to do so within the mask itself. Notably, sneezing and coughing are both particularly effective ways of spreading viral particles, so the former option is not recommended. In the alternative, should the wearer opt to sneeze or cough within the mask, it is necessary to replace the mask immediately thereafter. Thus, a wearer must always keep at least one, if not more, spare masks readily available. In the event that the wearer does not have a spare, they are forced to remain wearing the soiled mask, which is uncomfortable, unhygienic, and noticeably less effective when wet. A similar issue can arise if the wearer has a runny nose (e.g., a child wearer). Accordingly, there remains a need for devices and methods for preventing the transmission of air contaminants to or from a wearer that are re-usable, and yet still able to accommodate a wearer experiencing cold-like symptoms, or who simply has to sneeze. These needs and other needs may be satisfied by the various aspects of the present disclosure.

### SUMMARY

In accordance with the purpose(s) of the invention, as embodied and broadly described herein, the invention, in one aspect, relates to filters, filter assemblies, face masks, and face mask assemblies, and methods of making and using same.

Thus, disclosed herein are filters for preventing the transmission of air contaminants to or from a wearer. In one aspect, the filter can comprise a plurality of layers. In this aspect, each layer is joined together at a common edge. In a further aspect, each layer is not joined together at an opposing edge that is oppositely disposed relative to the common edge. In a further aspect, each layer has an interior surface, and each layer is not joined together at the interior surface. In a further aspect, the filter can comprise exactly three layers. In one aspect, it is contemplated that a second layer is dispersed between a first and a third layer, wherein each layer is joined together at a common edge. In a further aspect, the filter consists of material configured to refine air contaminants. In a further aspect, one or more layers has a perforation or other detachable connection adjacent to the common edge that runs in a direction parallel to the common edge.

Also disclosed herein are filter assemblies for preventing the transmission of air contaminants to or from a wearer. In one aspect, the filter assembly can comprise a pocket having a side edge that defines an opening. In another aspect, the filter assembly can comprise a filter. In this aspect, the filter can comprise a plurality of layers, wherein at least one layer is configured for insertion into the pocket via the opening. In still another aspect, each layer is joined together at a common edge. In yet another aspect, each layer is not joined together at an opposing edge that is oppositely disposed relative to the common edge. In one aspect, it is contemplated that the filter assembly can comprise a pocket having a side edge that defines an opening, and a filter having a plurality of layers, wherein at least one layer is configured for insertion into the pocket via the opening. In a further aspect, the pocket can consist of one or more breathable materials. In still another aspect, the filter can comprise exactly three layers, wherein each layer is joined together at a common edge. In yet another aspect, a second layer is dispersed between a first and a third layer, and the second layer is configured for insertion into the pocket via the opening. In a further aspect, one or more layers has a perforation adjacent to the common edge that runs in a direction parallel to the common edge.

Also disclosed herein are face masks for preventing the transmission of air contaminants to or from a wearer. In one aspect, the face mask can comprise a body and a pair of straps. In another aspect, the body can have a bottom edge, a pair of side edges, and an inner surface configured to be worn against a wearer's face. In still another aspect, the body comprises a pleat disposed between the side edges. In yet another aspect, the pair of straps can have a first end connected to the body adjacent to the bottom edge, wherein each first end is oppositely disposed relative to one another. In one aspect, it is contemplated that the face mask can comprise a body having a top edge, a bottom edge, a pair of side edges, and an inner surface configured to be worn against a wearer's face, and a pair of straps having a first end and a second end, wherein each first end is connected to the body adjacent to the bottom edge of the body, and wherein each first end is oppositely disposed relative to one another. In another aspect, the body can consist of a breathable material. In still another aspect, the body can comprise a plurality of pleats disposed between the side edges. In yet another aspect, the bottom edge of the body is stretchable between a retracted length and an extended length. In another aspect, each second end of the pair of straps can comprise a first attachment member configured for engagement with a second attachment member located adjacent to the top edge of the body, wherein each second attachment member is oppositely disposed relative to one another.

Also disclosed herein are face mask assemblies for preventing the transmission of air contaminants to or from a wearer. In one aspect, the face mask assembly can comprise a face mask and a pocket having a side edge that defines an opening. In another aspect, the face mask can comprise a body having a bottom edge, a pair of side edges, and an inner surface configured to be worn against a wearer's face. In a further aspect, the body of the face mask can consist of a breathable material. In still another aspect, the body of the face mask can comprise a plurality of pleats disposed between the side edges. In yet another aspect, the bottom edge of the body of the face mask is stretchable between a retracted length and an extended length. In still another aspect, the face mask can further comprise a pair of straps having a first end connected to the body adjacent to the bottom edge, and wherein each first end is oppositely disposed relative to one another. In yet another aspect, the pair of straps also have a second end. In still another aspect, each second end can comprise a first attachment member configured for engagement with a second attachment member located adjacent to the top edge of the body, wherein each second attachment member is oppositely disposed relative to one another. In a further aspect, the pocket is attached to the inner surface of the face mask. In one aspect, it is contemplated that the face mask assembly can also comprise a filter having a plurality of layers, wherein each layer is joined together at a common edge, and wherein each layer is not joined together at an opposing edge that is oppositely disposed relative to the common edge. In another aspect, the pocket has an exterior surface with a front face and a back face. In still another aspect, the filter can comprise three layers, wherein a second layer is dispersed between a first and a third layer, and wherein the second layer is configured for insertion into the pocket via the opening such that the second layer, when inserted, is separated from the first layer by the front face of the pocket and from the third layer by the back face of the pocket, and the first layer is between the inner surface of the body of the face mask and the exterior surface of the pocket, and the third layer is between a wearer's face and the exterior surface of the pocket. In yet another aspect, the first can comprise exactly three layers.

Also disclosed herein are kits for preventing the transmission of air contaminants to or from a wearer. In one aspect, the kit can comprise a disclosed face mask, and one or more selected from: (a) a pocket having a side edge that defines an opening; (b) a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening; (c) a filter layer comprising a pair of opposing side edges, an adhesive strip, and a removable liner covering the adhesive strip, wherein the adhesive strip is adjacent to one of the side edges and runs in a direction parallel to that side edge; (d) instructions for attaching a pocket to a face mask; (e) instructions for inserting a filter into a pocket; and (f) instructions for replacing a filter. In a further aspect, the kit can comprise a disclosed face mask assembly, and one or more selected from: (a) a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening; (b) a filter layer comprising a pair of opposing side edges, an adhesive strip, and a removable liner covering the adhesive strip, wherein the adhesive strip is adjacent to one of the side edges and runs in a direction parallel to that side edge; (c) instructions for attaching a pocket to a face mask; (d) instructions for inserting a filter into a pocket; and (e) instructions for replacing a filter. In still another aspect, the kit can comprise a disclosed pocket, and one or more selected from: (a) a face mask; (b) a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening; (c) a filter layer comprising a pair of opposing side edges, an adhesive strip, and a removable liner covering the adhesive strip, wherein the adhesive strip is adjacent to one of the side edges and runs in a direction parallel to that side edge; (d) instructions for attaching a pocket to a face mask; (e) instructions for inserting a filter into a pocket; and (f) instructions for replacing a filter. In yet another aspect, the kit can comprise a disclosed filter, and one or more selected from: (a) a filter layer comprising a pair of opposing side edges, an adhesive strip, and a removable liner covering the adhesive strip, wherein the adhesive strip is adjacent to one of the side edges and runs in a direction parallel to that side edge; (b) a face mask; (c) a pocket having a side edge that defines an opening; (d) instructions for attaching a pocket to a face mask; (e) instructions for inserting a filter into a pocket; and (f) instructions for replacing a filter.

Also disclosed herein are methods of making a disclosed filter or filter assembly.

Also disclosed herein are methods of making a disclosed face mask or face mask assembly.

Also disclosed are methods for preventing the transmission of air contaminants to or from a wearer. In one aspect, the method can comprise positioning a face mask, as described herein, over the nose and mouth of a wearer. In another aspect, the method can comprise selectively securely attaching a first strap of the pair of straps over a first ear of the wearer. In still another aspect, the method can comprise selectively securely attaching a second strap of the pair of straps over a second ear of the wear. In yet another aspect, the method can comprise selectively securely attaching a first attachment member on one end (e.g., a first end, a second end) of a first strap of the pair of straps to a second attachment member located adjacent to an edge (e.g., a top edge, a bottom edge) of the body. In still another aspect, the method can comprise selectively securely attaching a first attachment member on one end (e.g., a first end, a second end) of a second strap of the pair of straps to a second attachment member located adjacent to an edge (e.g., a top edge, a bottom edge) of the body, wherein each second attachment member is oppositely disposed relative to one another.

Also disclosed are methods for attaching a pocket to a face mask, wherein the face mask can comprise a body having an inner surface configured to be worn against a wearer's face. In one aspect, the method can comprise positioning a pocket, as disclosed herein, on the inner surface of the body of the face mask. In another aspect, the method can comprise selectively securely attaching a first attachment member of the pair of attachment members on the filter to a first attachment member located on the inner surface of the body. In still another aspect, the first attachment member of the pair of attachment members on the filter is located proximate to the common edge of the filter. In yet another aspect, the method can comprise selectively securely attaching a second attachment member of the pair of attachment members on the filter to a second attachment member located on the inner surface of the body, wherein the first and second attachment members of the body are oppositely disposed relative to one another. In still another aspect, the second attachment member of the pair of attachment members on the filter is located on a side of one layer of the filter, wherein the side is oppositely disposed relative to the common edge of the filter.

Also disclosed are methods for inserting a filter into a pocket. In one aspect, the method can comprise inserting a layer of a filter, as disclosed herein, into a pocket via the opening. In another aspect, the method can comprise selectively inserting a single layer of the filter into the pocket via the opening. In still another aspect, the method can comprise selectively inserting more than one layer of the filter into the pocket via the opening. In one aspect, it is contemplated that the filter can comprise three layers, wherein a second layer is dispersed between a first layer and a third layer. In a further aspect, the method can comprise selectively inserting the second layer into the pocket via the opening. In still another aspect, the pocket has an exterior surface with a front face and a back face. In yet another aspect, the method can comprise selectively inserting the second layer into the pocket via the opening, such that the first layer is separated from the second layer by the front face of the pocket and the third layer is separated from the second layer by the back face of the pocket. In this way, the filter can be readily inserted into and removed from the pocket via the common edge, allowing for easy disposal and/or replacement.

Also disclosed are methods for removing a layer of filter. In one aspect, the method can comprise removing a layer of a filter, as disclosed herein, by, for example, tearing the layer off of the filter via the perforation. In this way, a single layer of the filter can be removed and/or disposed of when desired (e.g., after use).

Also disclosed are methods for adding a layer to a filter. In one aspect, the method can comprise removing a removable liner from a filter layer, as disclosed herein, thereby revealing an adhesive strip. In another aspect, the method can comprise aligning the filter layer with the filter such that the adhesive strip is aligned with the common edge. In still another aspect, the method can comprise attaching the filter layer to the filter via the adhesive strip. In this way, an additional layer can be added to the filter, when desired.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying drawings, which are incorporated in and constitute a part of this specification, illustrate several aspects of the invention and together with the description, serve to explain the principles of the invention.

FIG. 1A-E show representative top views of a filter comprising two layers (FIG. 1A), three layers (FIG. 1B), and five layers (FIG. 1C). FIG. 1D and FIG. 1E show a filter comprising three layers, wherein one or more of the layers has a perforation.

FIG. 2A and FIG. 2B show representative images of a left side view (FIG. 2A) and a right side view (FIG. 2B) of a pocket.

FIG. 3A-E show a representative top view (FIG. 3A) and representative side views (FIG. 3B-E) of a filter assembly comprising a pocket and a filter. Referring to FIG. 3B-E, attachment members are located proximate to a common edge (FIG. 3B), proximate to the edge that opposes the common edge (FIG. 3C), both proximate to the common edge and proximate to the edge that opposes the common edge (FIG. 3D), and both proximate to the common edge and proximate to the edge that opposes the common edge as well as proximate to a top edge (FIG. 3E).

FIG. 4A-D show representative side views of a face mask comprising a body and a pair of straps in which one end of each strap is fixedly connected to the body adjacent to the bottom edge (FIG. 4A), one end of each strap is fixedly connected to the body adjacent to the bottom edge and the other end of each strap is fixedly connected to the body adjacent to the top edge (FIG. 4B), one end of each strap is reversibly connected to the body adjacent to the bottom edge (FIG. 4C), and one end of each strap is reversibly connected to the body adjacent to the bottom edge and the other end of each strap is capable of reversibly attaching to the body adjacent to the top edge (FIG. 4D).

FIG. 5A-F show additional representative side views of a face mask.

FIG. 6A-C show representative side views of a face mask in which attachment members are located proximate to each side edge (FIG. 6A), proximate to the top edge (FIG. 6B), and proximate to each side edge and to the top edge (FIG. 6C).

FIG. 7A and FIG. 7B show representative side views of a face mask assembly comprising a face mask and a pocket (FIG. 7A) and further comprising a filter with at least one central layer inserted into the pocket via the opening (FIG. 7B).

FIG. 8A-D show a representative front view of a face mask (FIG. 8A), a a representative side view of a face mask assembly comprising a face mask and a pocket (FIG. 8B), a a representative side view of a face mask assembly comprising a face mask, a pocket, and a filter with at least one central layer inserted into the pocket via the opening (FIG. 8C), and a representative back view of a face mask (FIG. 8D).

FIG. 9A-D show representative front views of a filter layer (FIG. 9A and FIG. 9C), a representative back view of a filter layer (FIG. 9B), and a representative side view of a filter layer (FIG. 9D).

### DESCRIPTION

The present invention can be understood more readily by reference to the following detailed description, examples, drawings, and claims, and their previous and following descriptions. However, before the present devices and/or methods are disclosed and described, it is to be understood that this invention is not limited to the specific devices and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a fastener” can include two or more such fasteners unless the context indicates otherwise.

As used in the specification and in the claims, the term “comprising” can include the aspects “consisting of” and “consisting essentially of.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” mean that the subsequently described event or circumstance may or may not occur, and that the description includes instances where said event or circumstance occurs and instances where it does not.

The word “or” as used herein means any one member of a particular list and, in an alternative aspect, can also include any combination of members of that list.

The terms “first,” “second,” “first part,” “second part,” and the like, as used herein, do not denote any order, quantity, or importance, and are used to distinguish one element from another, unless specifically stated otherwise.

As used herein, “kit” means a collection of at least two components constituting the kit. Together, the components constitute a functional unit for a given purpose. Individual member components may be physically packaged together or separately. For example, a kit comprising an instruction for using the kit may or may not physically include the instruction with other individual member components. Instead, the instruction can be supplied as a separate member component, either in a paper form or an electronic form, which may be supplied on computer readable memory device or downloaded from an internet website, or as recorded presentation.

As used herein, “instruction(s)” means documents describing relevant materials or methodologies pertaining to a kit. These materials may include any combination of the following: background information, list of components and their availability information (purchase information, etc.), brief or detailed protocols for using the kit, trouble-shooting, references, technical support, and any other related documents. Instructions can be supplied with the kit or as a separate member component, either as a paper form or an electronic form, which may be supplied on computer readable memory device or downloaded from an internet website, or as recorded presentation. Instructions can comprise one or multiple documents, and are meant to include future updates.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

### A. Filter Layers, Filters, and Filter Assemblies

In one aspect, disclosed are filters comprising a plurality of layers, wherein each layer is joined together at a common edge, and wherein each layer is not joined together at an opposing edge that is oppositely disposed relative to the common edge. Thus, in various aspects, the filter comprises at least two layers, such as, for example, 2, 3, 4, 5, 6, or more layers. In a further aspect, the filter comprises exactly two layers. In a still further aspect, the filter comprises more than two layers. In yet a further aspect, the filter comprises exactly three layers. In an even further aspect, the filter comprises more than three layers.

In one aspect, disclosed are filters comprising exactly three layers, wherein a second layer is dispersed between a first and a third layer, wherein each layer is joined together at a common edge, and wherein the filter consists of material configured to refine contaminants.

In one aspect, disclosed are filter layers comprising a pair of opposing side edges, an adhesive strip, and a removable liner covering the adhesive strip, wherein the adhesive strip is adjacent to one of the side edges and runs in a direction parallel to that side edge. In this way, the removable liner can be removed, thereby revealing the adhesive strip, and the layer can be attached to the outermost layer of the filter

In one aspect, disclosed are filter assemblies comprising: (a) a pocket having a side edge that defines an opening; and (b) a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening.

In one aspect, disclosed are filter assemblies comprising: (a) a pocket consisting of one or more breathable materials, and having a side edge that defines an opening; and (b) a filter comprising exactly three layers, wherein each layer is joined together at a common edge, wherein each layer is not joined together at an opposing edge that is oppositely disposed relative to the common edge, wherein a second layer is dispersed between a first and a third layer, and wherein the second layer is configured for insertion into the pocket via the opening.

The disclosed filter, which can be used to prevent the transmition of air contaminants, beneficially contains multiple layers that are joined together at one end and free (i.e., disconnected) at the other end. When in use with a pocket, at least one layer of the filter is inserted into the pocket and at least one layer is located exterior to the pocket on two opposing sides of the pocket. The filter and the pocket together (i.e., the filter assembly) can then be attached to or otherwise combined with a surface of a face mask, such that only one layer of the filter is between a side of the pocket and the surface of the face mask and one layer of the filter is in direct contact with a wearer's face. In this way, the face mask itself does not become contaminated as readily. Indeed, without wishing to be bound by theory, it has been found that the layers of the filter, alone or in combination with the pocket, provide additional protection to the wearer when used in combination with a face mask. Moreover, having a common edge where each layer is joined together allows for the filter to be readily inserted into and/or removed from the pocket. In the event that the wearer sneezes, for example, the filter can then be disposed of and a new filter inserted. The mask can remain in place and continue to be used.

In various aspects, the pocket can also behave as a filter. For example, the front face and the back face of the pocket can also filter air contaminants. Thus, when used in combination with the filter (i.e., as a filter assembly) additional protection is offered.

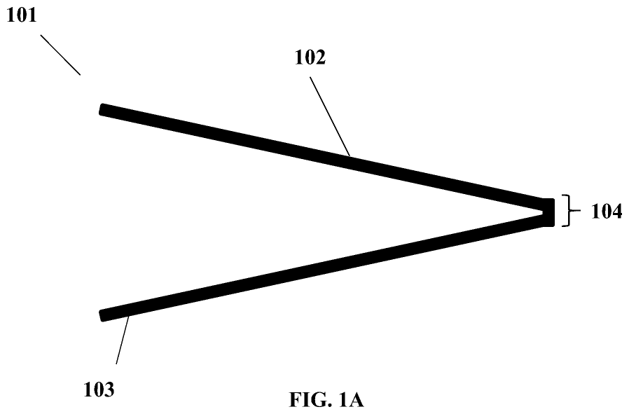

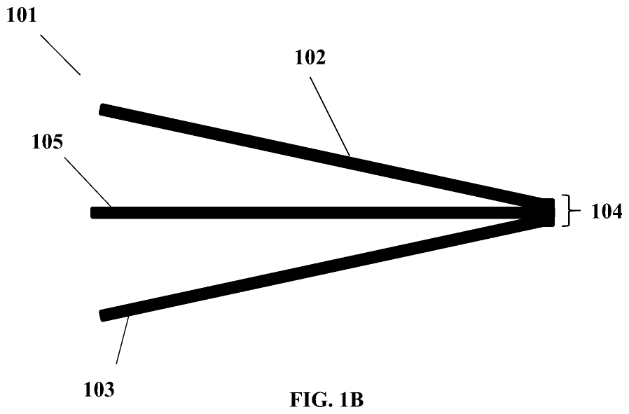

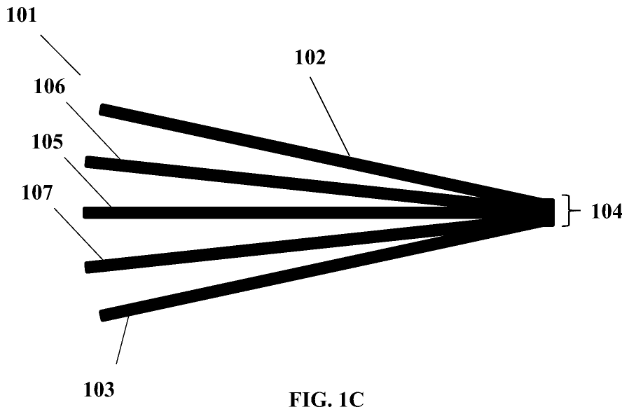

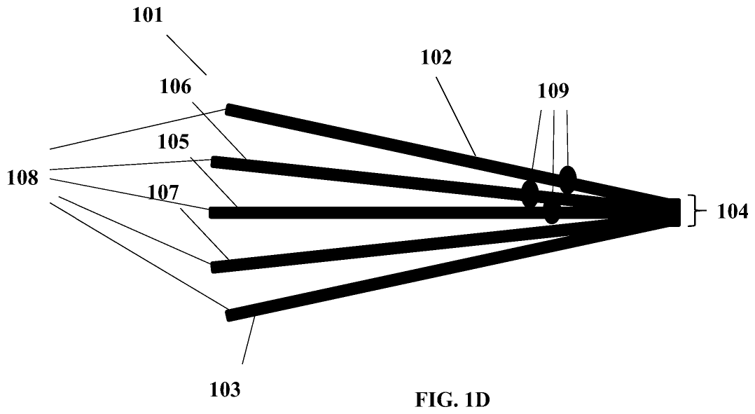

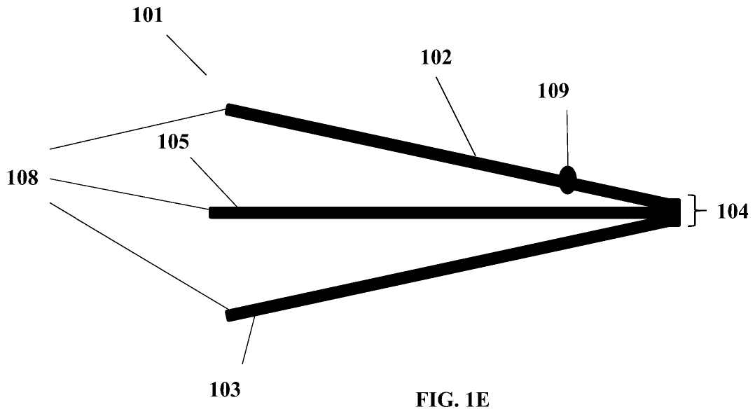

Referring to FIG. 1A-E, for example, filter 101 can comprise a plurality of layers such as, for example, two layers 102 and 103 (FIG. 1A), three layers 102, 103, and 105 (FIG. 1B), or five layers 102, 103, 105, 106, and 107 (FIG. 1C), although alternative numbers of layers are also contemplated. As shown, each layer is joined together at common edge 104, and is not joined together at opposing edge 108. When more than two layers are present, the additional layers are dispersed between first layer 102 and second layer 103. As shown in FIG. 1D and FIG. 1E, one or more layers can contain a perforation 109 adjacent to common edge 104 that runs in a direction parallel to common edge 104. In this way, a layer (e.g., 102, 105, 106) can be removed from the filter, and the filter itself can then be used again with the remaining layers.

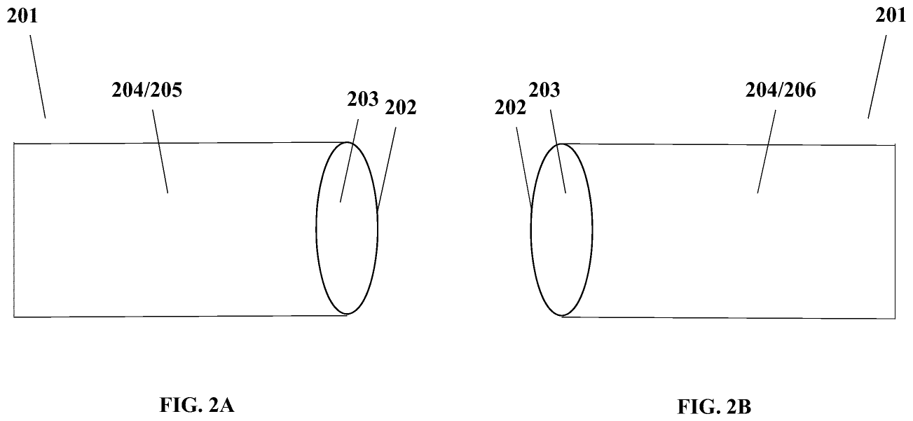

Referring to FIG. 2A and FIG. 2B, for example, pocket 201 has a side edge 202 that defines opening 203. As shown, pocket 201 has an exterior surface 204 with a front face 205 (FIG. 2A) and a back face 206 (FIG. 2B).

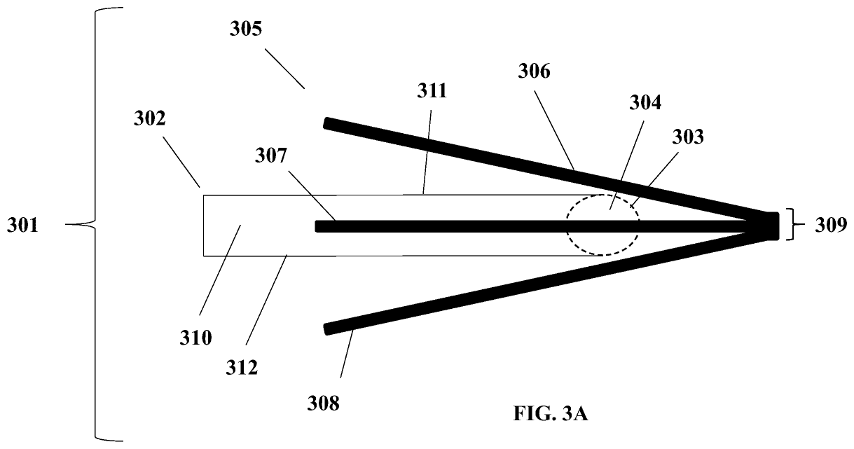

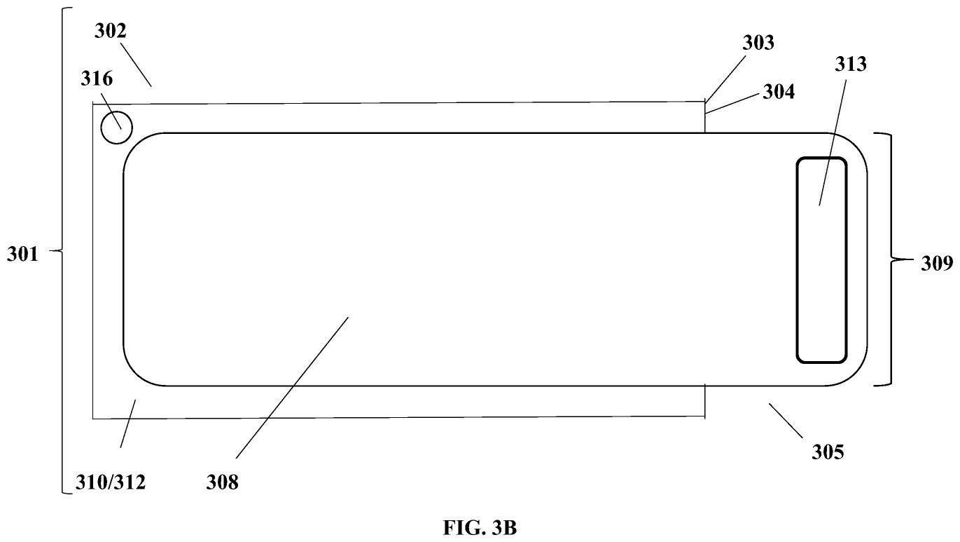

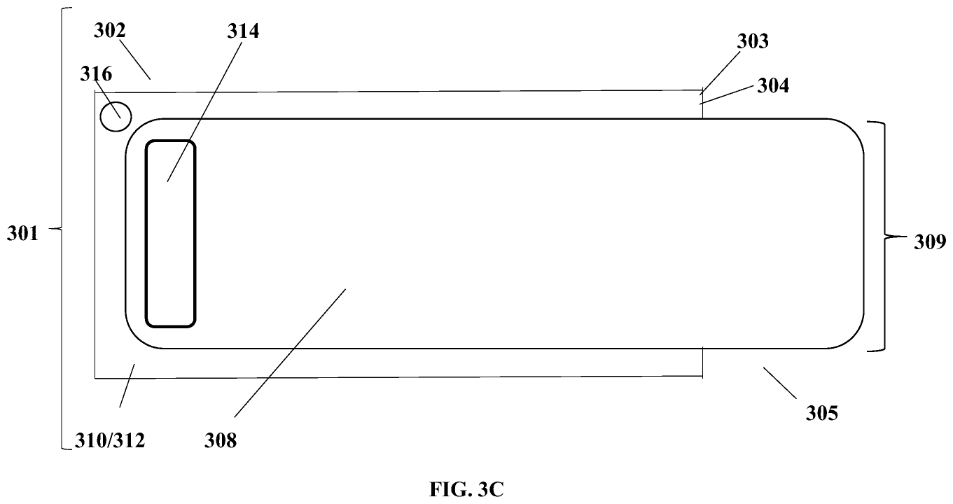

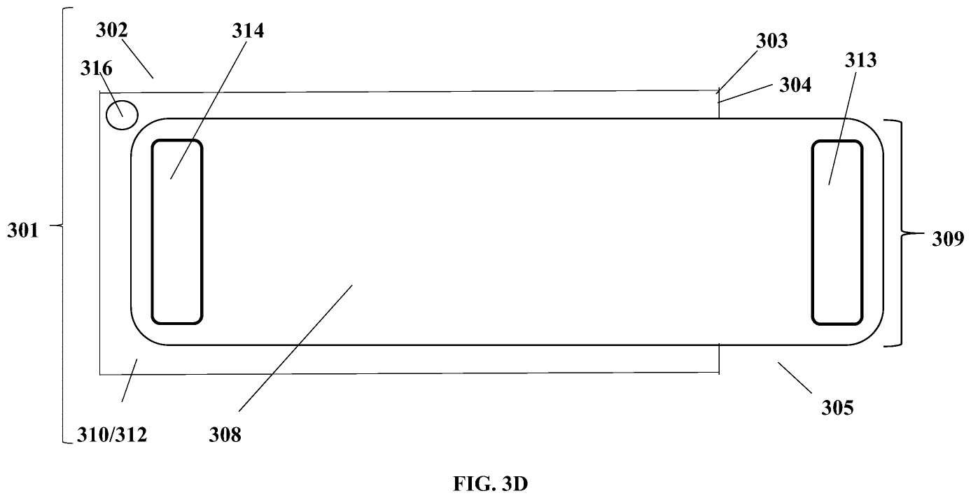

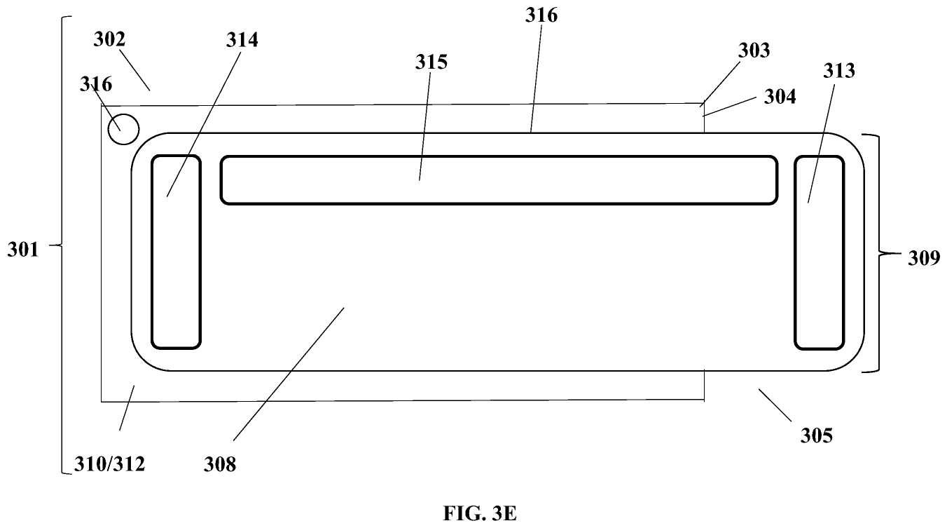

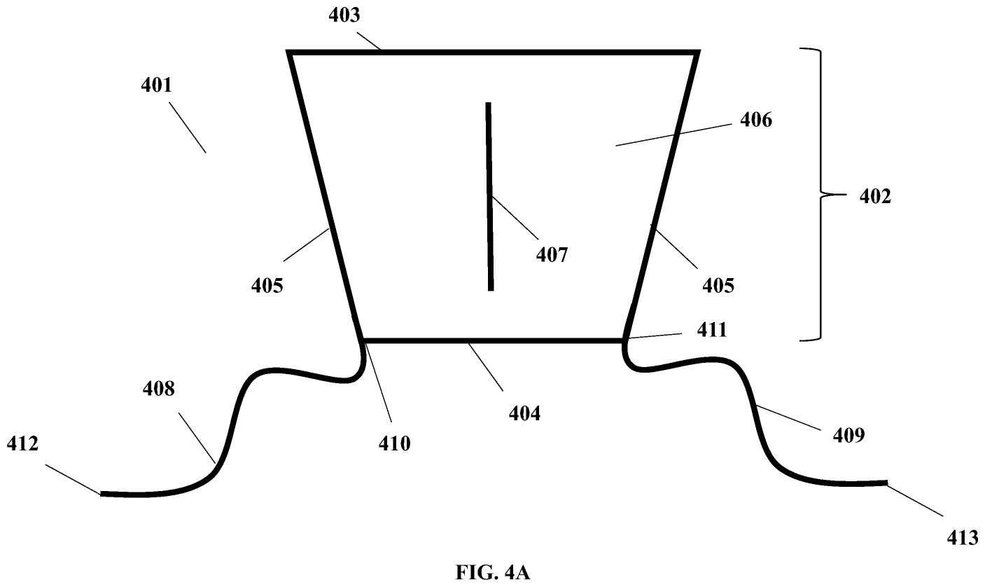

Referring to FIG. 3A, for example, filter assembly 301 can comprise pocket 302 and filter 305, which can optionally have the structure and features of filter 101 disclosed herein. Filter 305 has three layers that are joined together at common edge 309, although additional numbers of layers are also contemplated. As shown, second layer 307 is dispersed between first layer 306 and third layer 308. Pocket 302 has an exterior surface 310 with a front face 311 and back face 312, and a side edge 303 that defines opening 304. In various aspects, pocket 302 can also include an attachment member 316 for securing the pocket to a face mask as further disclosed herein, although alternative embodiments in which an attachment member is not present on the pocket are also envisioned. See FIG. 3B-D. As shown, third layer 307 is at least partially inserted into opening 304, thereby forming filter assembly 301. In this way, first layer 306 is separated from second layer 307 by front face 311. Similarly, third layer 308 is separated from second layer 307 by back face 312.

Side views of a representative filter assembly as shown in FIG. 3A are shown in FIG. 3B-E. In various aspects, filter 305 can include an attachment member (e.g., hook-and-loop fasteners, tape, tack, etc.) that facilitates securing the filter to a face mask, although attachment members are not required. For example, as shown in FIG. 3B, filter 305 can include attachment member 313 on third layer 308, proximate to common edge 309, although alternative arrangements of attachment members are also contemplated. Thus, as shown in FIG. 3C, filter 305 can include attachment member 314 on the “other side” of third layer 308, proximate to the edge of third layer 308 that opposes common edge 309. Alternatively, as shown in FIG. 3D, filter 305 can include a pair of attachment members on third layer 308—attachment member 313 proximate to common edge 309 and attachment member 314 on the other side of third layer 308. Alternatively, as shown in FIG. 3E, filter 305 can include multiple attachment members on third layer 308 such as attachment member 313 proximate to common edge 309, attachment member 314 on the other side of third layer 308, proximate to the edge of third layer 308 that opposes common edge 309, and attachment member 315 proximate to top edge 316 of third layer 308. As would be readily appreciated by one of ordinary skill in the art, attachment members, when present, are located on a single face of a single layer of the filter such that each attachment member is configured to attach to a complementary attachment member located on a single face of a face mask. Thus, the attachment members, when present, are located on an outermost face of an outermost layer of the filter.

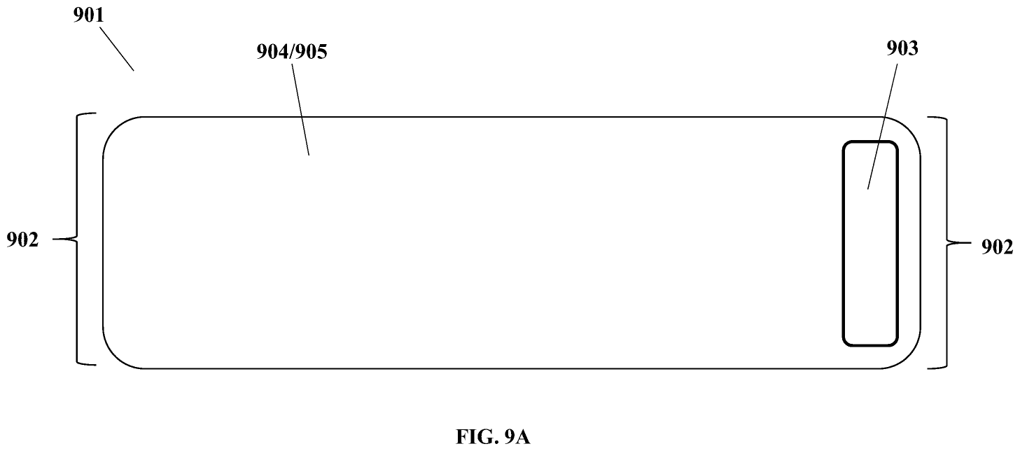

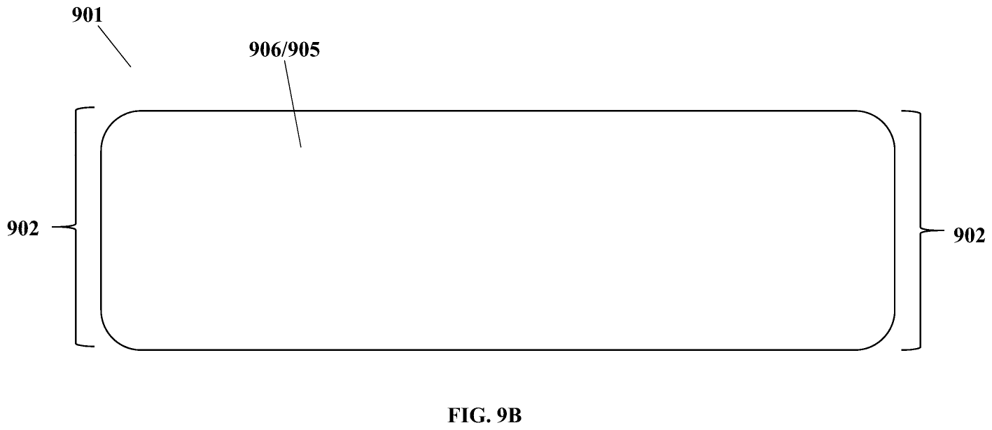

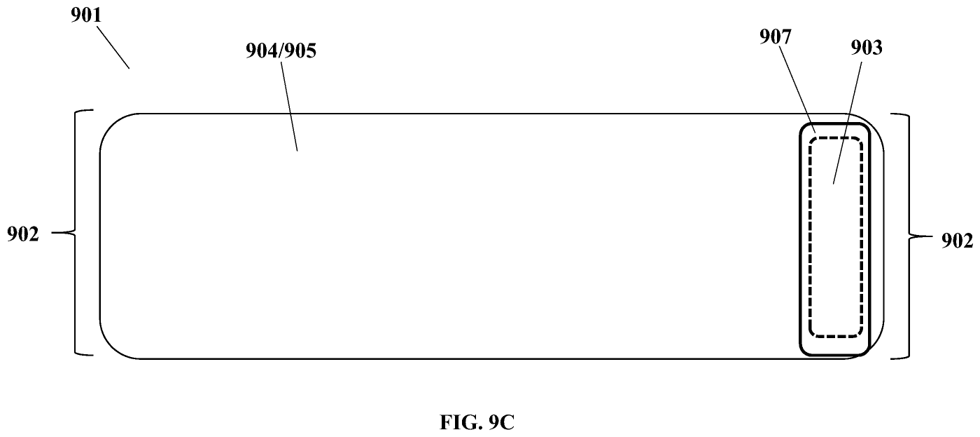

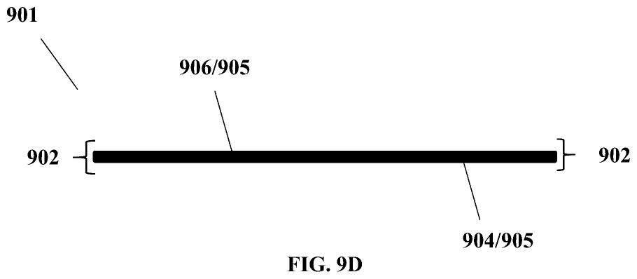

Referring to FIG. 9A-D, for example, filter layer 901 can comprise a pair of opposing side edges 902, an exterior surface 905 having a front face 904 and a back face 905, an adhesive strip 903, and, optionally, a removable liner 907 covering adhesive strip 903. As would be appreciated by one of ordinary skill in the art, removable liner 907 can be removed to reveal adhesive strip 903, which can then be used to attach filter layer 901 to one face of a filter 305 (e.g., the outermost face of the outermost layer).

In various aspects, each layer has an interior surface, wherein each layer is not joined together at the interior surface.

In various aspects, the filter comprises three layers, wherein a second layer is dispersed between a first layer and a third layer. In a further aspect, the first, second, and third layer are the only layers in the filter.

In various aspects, the filter consist of material configured to refine air contaminants. Examples of material configured to refine air contaminants include, but are not limited to, paper, cotton, and muslin. In a further aspect, the filter comprises paper. In a still further aspect, the filter consists of paper.

In various aspects, one or more layers has a perforation adjacent to the common edge that runs in a direction parallel to the common edge. In this way, a layer can be removed from the filter, and the filter itself can then be used again.

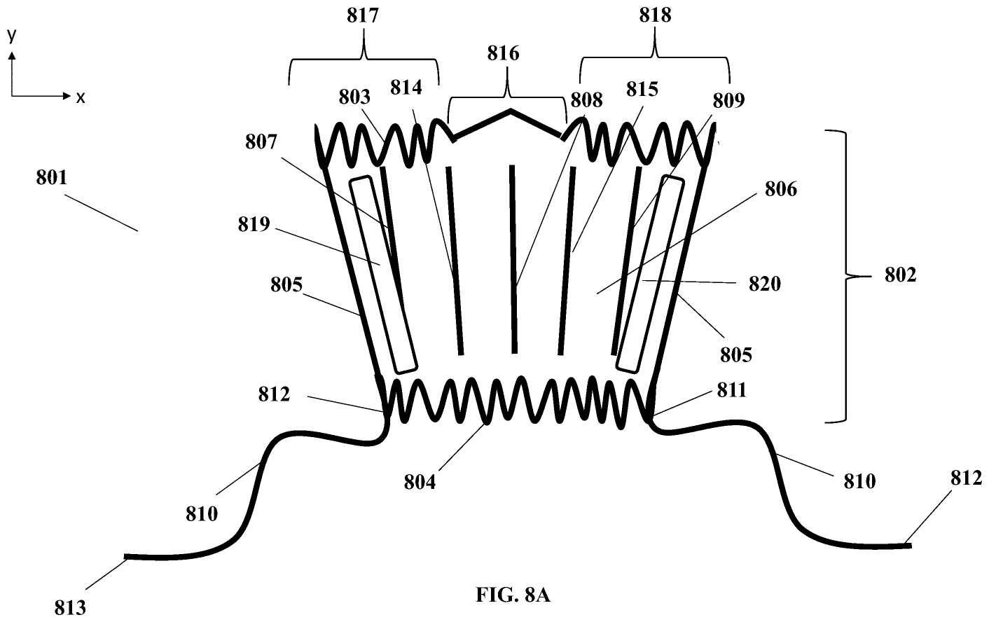

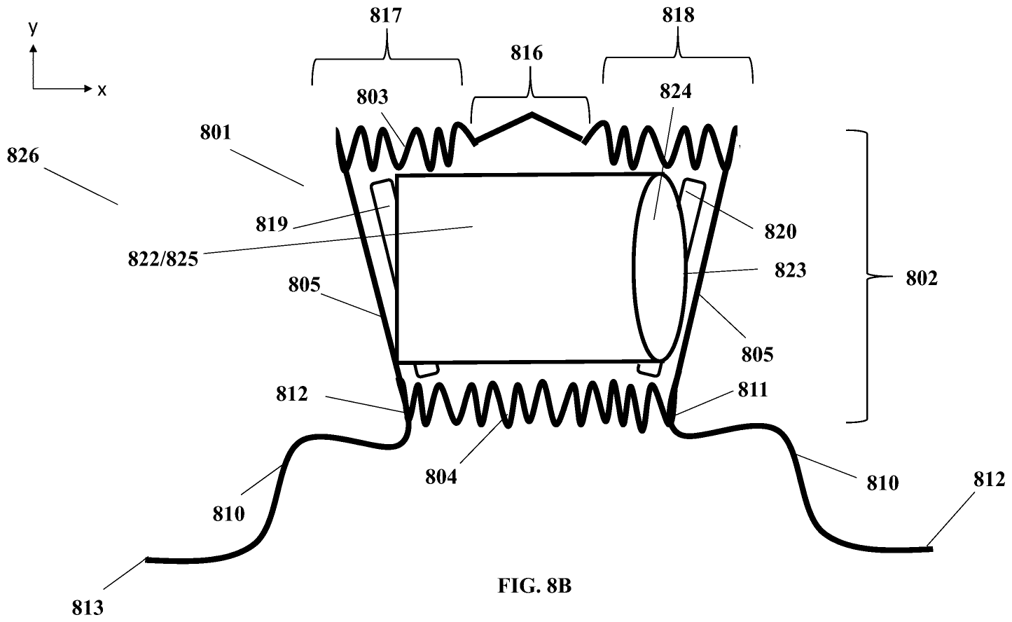

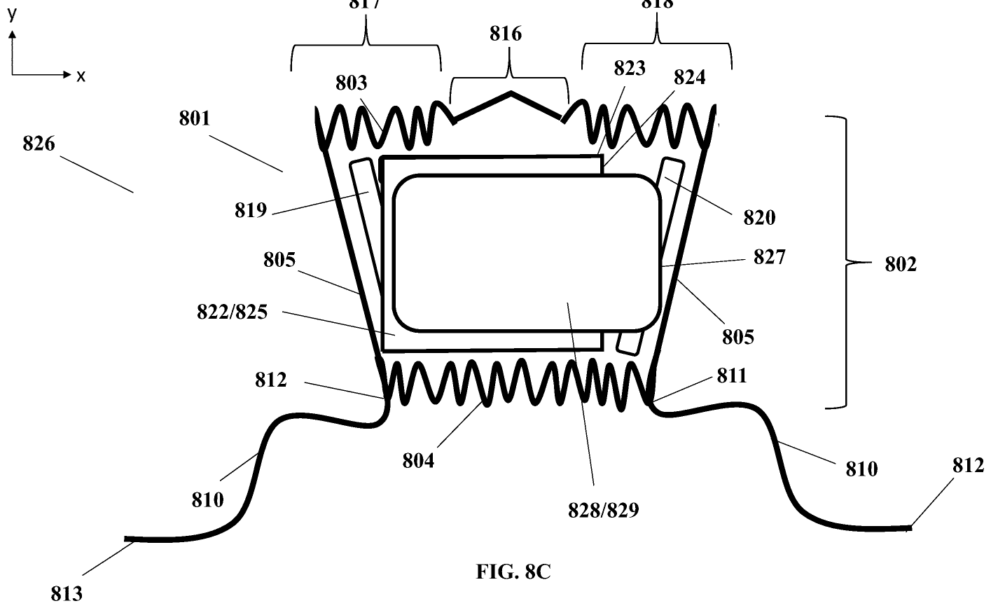

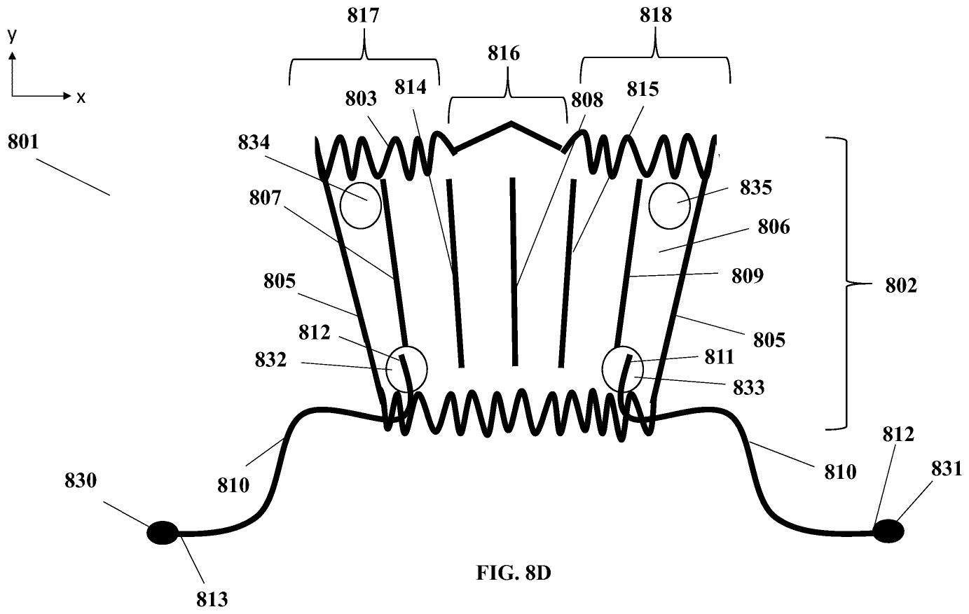

In various aspects, the filter has a depth in a direction parallel to a z-axis relative to the x-y axis as shown in, for example, FIG. 8A-C.

In various aspects, the filter has a depth of from about 0.10 inches to about 0.40 inches, about 0.10 inches to about 0.30 inches, about 0.10 inches to about 0.20 inches, about 0.20 inches to about 0.40 inches, about 0.30 inches to about 0.40 inches, or about 0.20 inches to about 0.30 inches. In a further aspect, the filter has a depth of about 0.25 inches.

In various aspects, the filter has a length in a direction parallel to an x-axis as shown in, for example, FIG. 8A-C.

In various aspects, the filter has a length of from about 5.0 inches to about 10.0 inches, about 5.0 inches to about 9.0 inches, about 5.0 inches to about 8.0 inches, abut 5.0 inches to about 7.0 inches, about 5.0 inches to about 6.0 inches, about 6.0 inches to about 10.0 inches, about 7.0 inches to about 10.0 inches, about 8.0 inches to about 10.0 inches, about 9.0 inches to about 10.0 inches, about 6.0 inches to about 9.0 inches, or about 7.0 inches to about 8.0 inches. In a further aspect, the filter has a length of about 7.75 inches.

In various aspects, each layer of the filter has a length of from about 5.0 inches to about 10.0 inches, about 5.0 inches to about 9.0 inches, about 5.0 inches to about 8.0 inches, abut 5.0 inches to about 7.0 inches, about 5.0 inches to about 6.0 inches, about 6.0 inches to about 10.0 inches, about 7.0 inches to about 10.0 inches, about 8.0 inches to about 10.0 inches, about 9.0 inches to about 10.0 inches, about 6.0 inches to about 9.0 inches, or about 7.0 inches to about 8.0 inches. In a further aspect, each layer of the filter has a length of about 7.75 inches.

In various aspects, each layer of the filter has the same length. In various further aspects, each layer of the filter has a different length.

In various aspects, the filter has a width in a direction parallel to a y-axis as shown in, for example, FIG. 8A-C.

In various aspects, the filter has a width of from about 2.0 inches to about 6.0 inches, about 2.0 inches to about 5.0 inches, about 2.0 inches to about 4.0 inches, about 2.0 inches to about 3.0 inches, about 3.0 inches to about 6.0 inches, about 4.0 inches to about 6.0 inches, about 5.0 inches to about 6.0 inches, about 3.0 inches to about 5.0 inches, or about 3.5 inches to about 4.5 inches. In a further aspect, the filter has a width of about 4.0 inches.

In various aspects, each layer of the filter has a width of from about 2.0 inches to about 6.0 inches, about 2.0 inches to about 5.0 inches, about 2.0 inches to about 4.0 inches, about 2.0 inches to about 3.0 inches, about 3.0 inches to about 6.0 inches, about 4.0 inches to about 6.0 inches, about 5.0 inches to about 6.0 inches, about 3.0 inches to about 5.0 inches, or about 3.5 inches to about 4.5 inches. In a further aspect, each layer of the filter has a width of about 4.0 inches.

In various aspects, each layer of the filter has the same width. In various further aspects, each layer of the filter has a different width.

In various aspects, the pocket comprises a breathable fabric. Examples of breathable fabrics include, but are not limited to, cotton, nylon, rayon, linen, muslin, silk, micromodal, chambray, and polyester. In a further aspect, the pocket comprises polyester. In a still further aspect, the pocket consists of one or more breathable fabrics.

In various aspects, the pocket has a length in a direction parallel to an x-axis as shown in, for example, FIG. 8A-C.

In various aspects, the pocket has a length of from about 5.0 inches to about 10.0 inches, about 5.0 inches to about 9.0 inches, about 5.0 inches to about 8.0 inches, abut 5.0 inches to about 7.0 inches, about 5.0 inches to about 6.0 inches, about 6.0 inches to about 10.0 inches, about 7.0 inches to about 10.0 inches, about 8.0 inches to about 10.0 inches, about 9.0 inches to about 10.0 inches, about 6.0 inches to about 9.0 inches, or about 7.0 inches to about 8.0 inches. In a further aspect, the pocket has a length of about 7.5 inches.

In various aspects, the length of the pocket is longer than the length of the filter. In various further aspects, the length of the pocket is shorter than the length of the filter. In various further aspects, the length of the pocket is approximately equal to the length of the filter.

In various aspects, the pocket has a width in a direction parallel to a y-axis as shown in, for example, FIG. 8A-C.

In various aspects, the pocket has a width of from about 2.0 inches to about 6.0 inches, about 2.0 inches to about 5.0 inches, about 2.0 inches to about 4.0 inches, about 2.0 inches to about 3.0 inches, about 3.0 inches to about 6.0 inches, about 4.0 inches to about 6.0 inches, about 5.0 inches to about 6.0 inches, about 3.0 inches to about 5.0 inches, or about 3.5 inches to about 4.5 inches. In a further aspect, the pocket has a width of about 4.0 inches.

In various aspects, the width of the pocket is larger than the width of the filter. In various further aspects, the width of the pocket is approximately equal to the width of the filter.

In various aspects, the pocket has an inseam of from about 0.10 inches to about 0.40 inches, about 0.10 inches to about 0.30 inches, about 0.10 inches to about 0.20 inches, about 0.20 inches to about 0.40 inches, about 0.30 inches to about 0.40 inches, or about 0.20 inches to about 0.30 inches. In a further aspect, the pocket has an inseam of about 0.25 inches.

In various aspects, one layer of the filter is configured for insertion into the pocket via the opening. In a further aspect, more than one layer of the filter is configured for insertion into the pocket via the opening.

In various aspects, the filter comprises three layers, wherein a second layer is dispersed between a first and a third layer, and wherein the second layer is configured for insertion into the pocket via the opening. In various aspects, the first, second, and third layers are the only layers in the filter.

In various aspects, the pocket has an exterior surface with a front face and a back face, wherein the second layer is inserted into the pocket via the opening, wherein the first layer is separated from the second layer by the front face of the pocket, and wherein the third layer is separated from the second layer by the back face of the pocket. In this way, the pocket, when in use with the filter, does not come in contact with a wearer's face. Rather, only a layer of the filter is in contact with the wearer's face. Thus, the filter can be readily removed and, if desired, disposed of after use, and a new, clean filter can be inserted into the pocket. Further, the layers of the filter in combination with the pocket add additional layers of protection for the wearer. Without being bound by theory, this may enhance the ability of the pocket to prevent the transmission of air contaminants.

In various aspects, the filter assembly further comprises an attachment member proximate to the common edge of the filter. Examples of attachment members include, but are not limited to, hook-and-loop fasteners, tape, and tack. In this way, the filter can be reversibly attached to an additional component such as, for example, a face mask. In a further aspect, the attachment member is tape.

In various aspects, the attachment member has a length in a direction parallel to an x-axis as shown in, for example, FIG. 8A-C.

In various aspects, the attachment member has a length of from about 0.30 inches to about 0.70 inches, about 0.30 inches to about 0.60 inches, about 0.30 inches to about 0.50 inches, about 0.30 inches to about 0.40 inches, about 0.40 inches to about 0.70 inches, about 0.50 inches to about 0.70 inches, about 0.60 inches to about 0.70 inches, about 0.40 inches to about 0.60 inches, or about 0.45 inches to about 0.55 inches. In a further aspect, the attachment member has a length of about 0.5 inches.

In various aspects, the attachment member has a width in a direction parallel to a y-axis as shown in, for example, FIG. 8A-C.

In various aspects, the attachment member has a width of from about 0.50 inches to about 4.0 inches, about 0.50 inches to about 3.0 inches, about 0.50 inches to about 2.0 inches, about 0.50 inches to about 1.0 inch, about 1.0 inch to about 4.0 inches, about 2.0 inches to about 4.0 inches, about 3.0 inches to about 4.0 inches, about 1.0 inch to about 3.0 inches, or about 1.5 inches to about 2.5 inches. In a further aspect, the attachment member has a width of about 2.0 inches.

In various aspects, each layer of the filter comprises a pair of opposing sides, wherein one side of each layer together comprises the common edge, and wherein the other side of at least one layer comprises an attachment member. In a further aspect, each layer of the filter comprises a pair of opposing sides, wherein one side of each layer together comprises the common edge, wherein the filter further comprises a pair of attachment members, wherein one attachment member is proximate to the common edge, and wherein the other attachment member is on the other side of at least one layer.

### B. Face Masks and Face Mask Assemblies

In one aspect, disclosed are face masks comprising: (a) a body having a top edge, a bottom edge, a pair of side edges, and an inner surface configured to be worn against a wearer's face, wherein the body comprises a pleat disposed between the side edges; and (b) a pair of straps having a first end connected to the body adjacent to the top edge or adjacent to the bottom edge, and wherein each first end is oppositely disposed relative to one another.

In one aspect, disclosed are face masks comprising: (a) a body consisting of a breathable material, and having a top edge, a bottom edge, a pair of side edges, and an inner surface configured to be worn against a wearer's face, wherein the body comprises a plurality of pleats disposed between the side edges, and wherein the bottom edge of the body is stretchable between a retracted length and an extended length; and (b) a pair of straps having a first end and a second end, wherein each first end is connected to the body adjacent to the bottom edge of the body, wherein each first end is oppositely disposed relative to one another, wherein each second end comprises a first attachment member configured for engagement with a second attachment member located adjacent to the top edge of the body, and wherein each second attachment member is oppositely disposed relative to one another.

In one aspect, disclosed are face mask assemblies comprising a disclosed face mask, and a pocket having a side edge that defines an opening, wherein the pocket is attached to the inner surface of the face mask. As would be understood by one of ordinary skill in the art, wearing a disclosed face mask in combination with a disclosed pocket can provide additional protection to the wearer compared to wearing the face mask alone, even when used without a filter inserted.

In one aspect, disclosed are face mask assemblies comprising: (a) a disclosed face mask; (b) a pocket having an exterior surface with a front face and a back face, and a side edge that defines an opening, wherein the pocket is attached to the inner surface of the face mask; and (c) a filter comprising exactly three layers, wherein each layer is joined together at a common edge, wherein each layer is not joined together at an opposing edge that is oppositely disposed relative to the common edge, wherein a second layer is dispersed between a first and a third layer, and wherein the second layer is configured for insertion into the pocket via the opening such that the second layer, when inserted, is separated from the first layer by the front face of the pocket and from the third layer by the back face of the pocket, and the first layer is between the inner surface of the body of the face mask and the back face of the exterior surface of the pocket.

The disclosed face mask, which can be used to prevent the transmition of air contaminants to or from a wearer, beneficially contains one or more pleats that run horizontally across the surface of the filter. Without wishing to be bound by theory, the pleat(s) allows the face mask to obtain both an expanded form and a retracted form, as well as a variety of different sizes or forms in between. In this way, the face mask can expand to accommodate a pocket and/or a filter without detracting from the space available for a wearer's face. In addition, the orientation of the pleat readily accommodates a wearer's nose, without unnecessary rubbing or irritation.

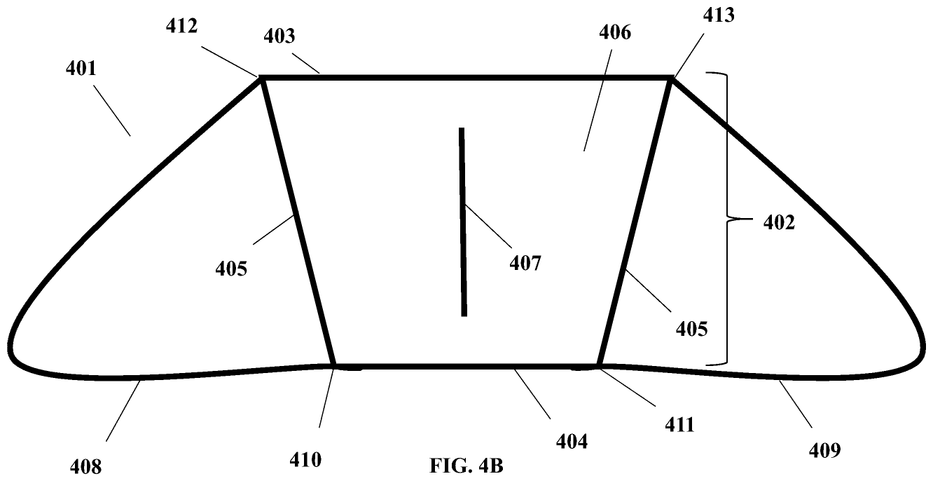

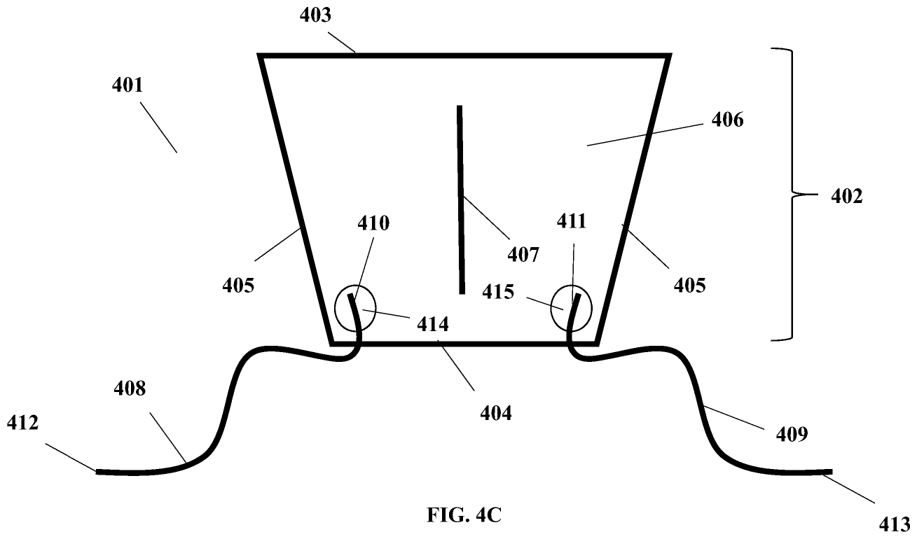

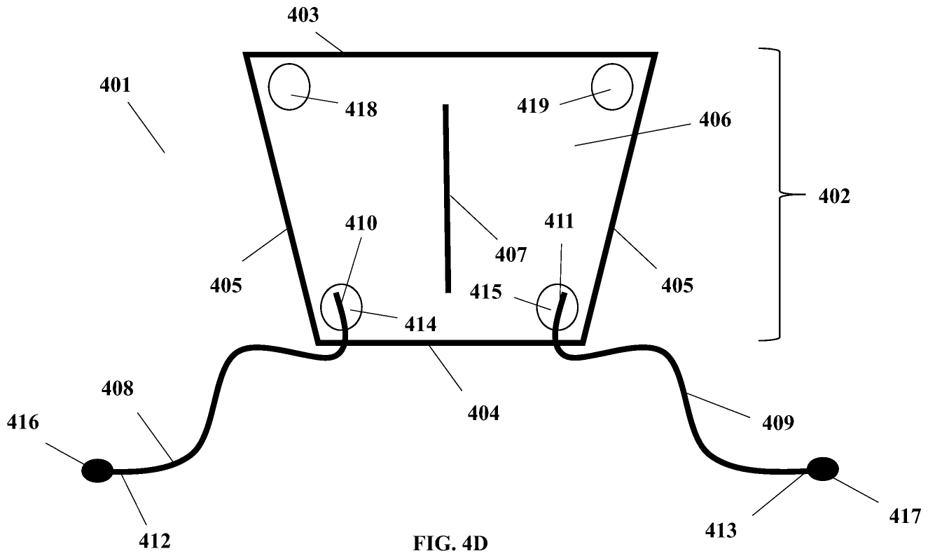

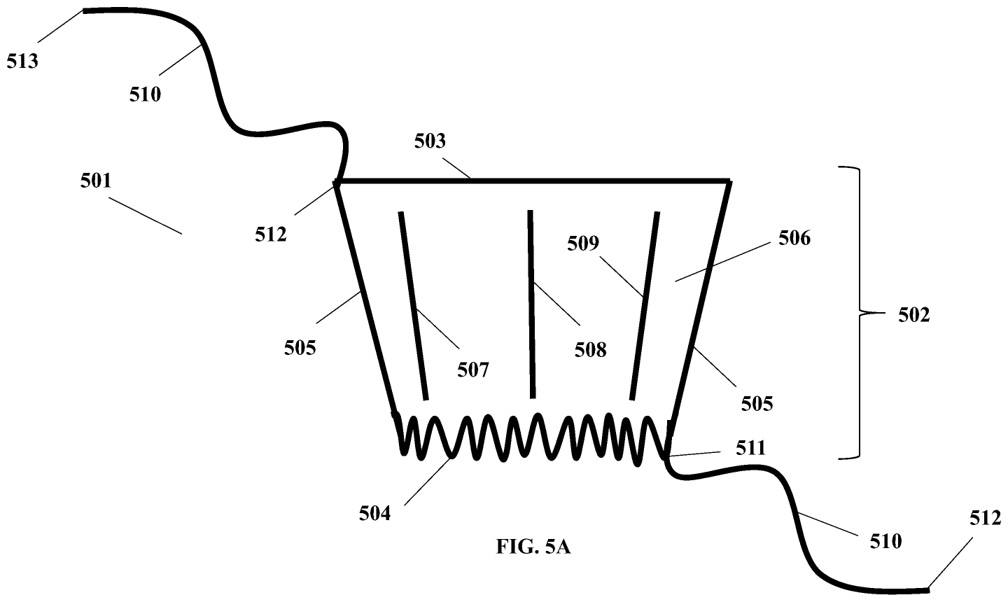

Referring to FIG. 4A-D, for example, face mask 401 can comprise body 402 and a pair of straps 408 and 409. Body 402 has a top edge 403, a bottom edge 404, a pair of side edges 405, an inner surface 406, and a pleat 407. As shown, body 402 has but a single pleat 407 centrally disposed between side edges 405; however, alternative numbers and arrangements of pleats between side edges 405 are also contemplated. Straps 408 and 409 have first ends 410 and 411 that are connected to body 402. For example, as shown in FIG. 4A and FIG. 4B, first ends 410 and 411 can be fixedly connected (e.g., via a seam, glue, etc.) to body 402 adjacent to bottom edge 404, wherein first end 410 and first end 411 are oppositely disposed relative to one another. It is also contemplated that first ends 410 and 410 can be connected (i.e., fixedly or reversibly) to body 402 adjacent to top edge 403, or that one first end can be connected adjacent to top edge 403 and the other first end can be connected adjacent to bottom edge 404. Alternatively, as shown in FIG. 4C and FIG. 4D, first ends 410 and 411 can be reversibly connected (e.g., via attachment members 414 and 415) to body 402 adjacent to bottom edge 404, wherein first end 410 and first end 411 are oppositely disposed relative to one another. In a similar manner, second ends 412 and 413 can be fixedly connected (FIG. 4B) or can have a first attachment member (e.g., 416 and 417, see FIG. 4D) that is configured for engagement with an opposed second attachment member (e.g., 418 and 419). For example, as shown in FIG. 4D, first ends 410 and 411 are connected adjacent to bottom edge 404, and so second attachment members 418 and 419 are located adjacent to top edge 403. As would be understood by one of ordinary skill in the art, second ends 412 and 413 need not be be fixedly attached or comprise an attachment member in order to secure the face mask. See, e.g., FIG. 4A and FIG. 4C. For example, straps 408 and 409 may encircle a wearer's head and be tied onto each other to secure the face mask. Alternatively, body 406 may contain relatively small holes adjacent to an edge that opposes the edge alongside which first ends 410 and 411 are connected. In this way, second ends 412 and 413 can be pulled through these holes and each strap tied onto itself. Alternative means of securing straps 408 and 409 would be understood by one of skill in the art.

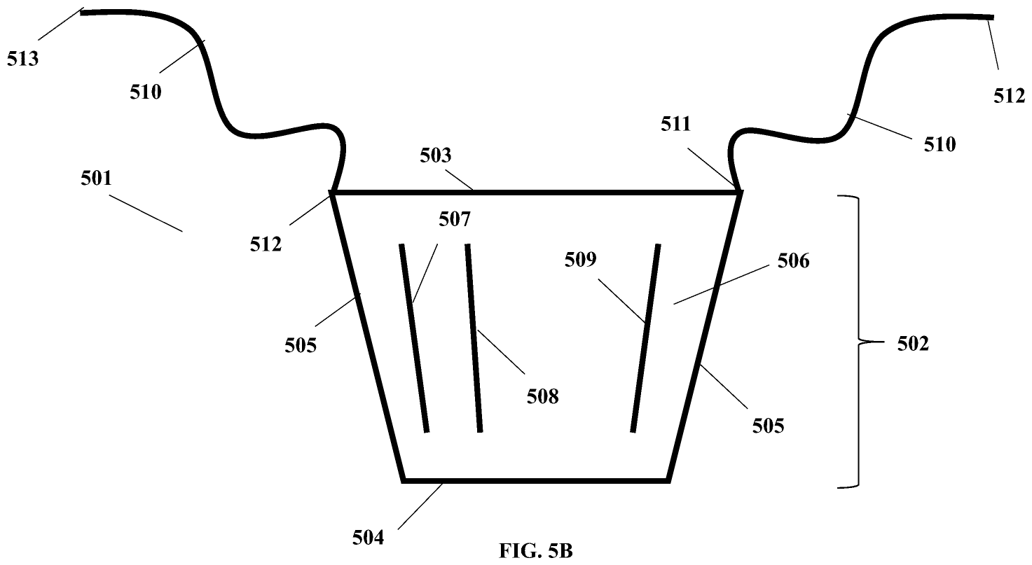

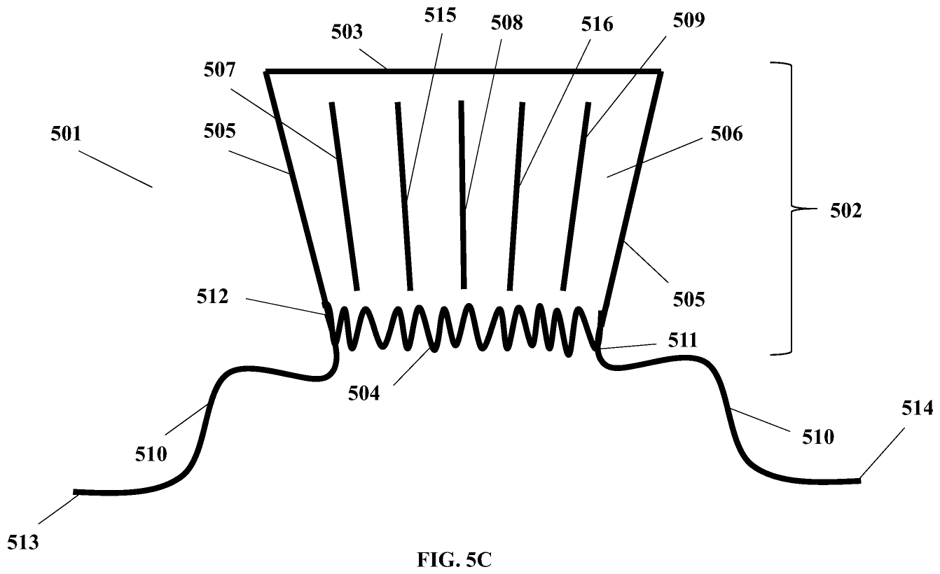

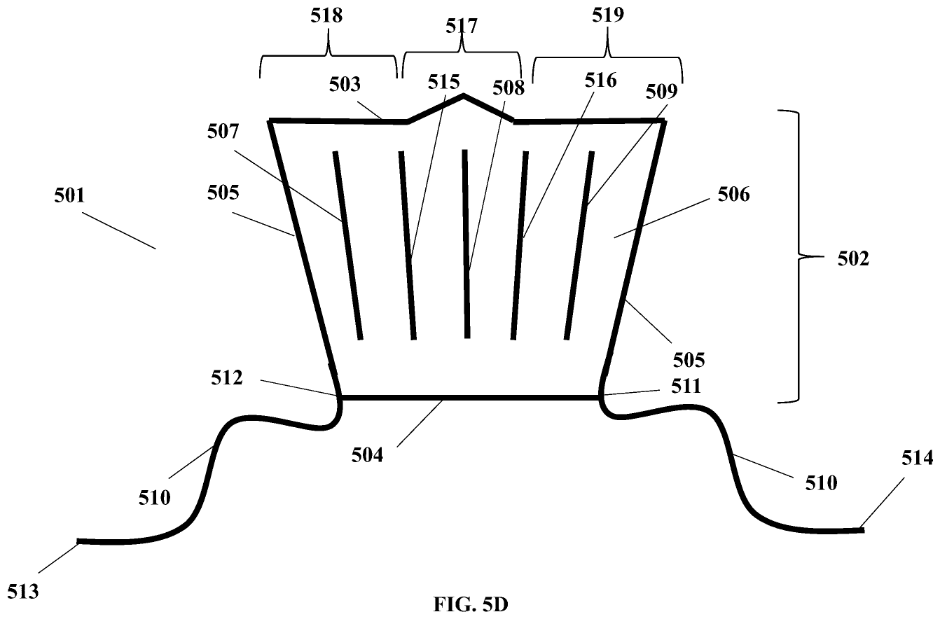

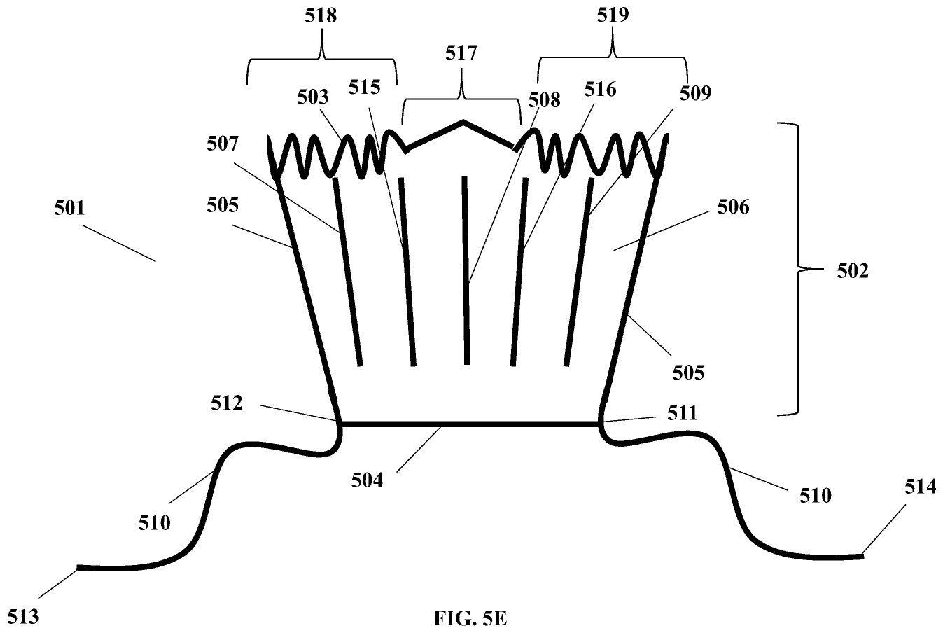

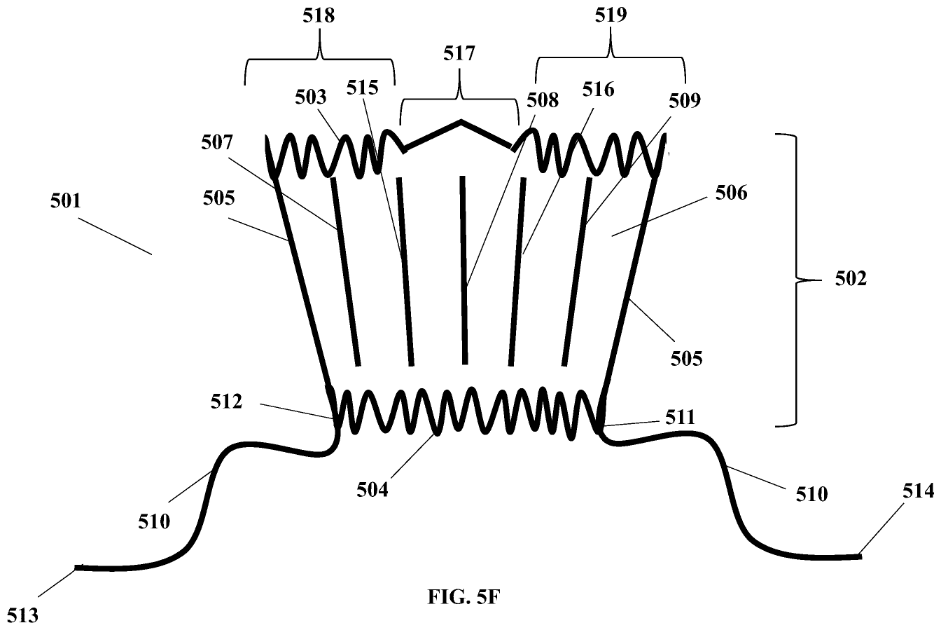

Referring to FIG. 5A-F, for example, face mask 501 can comprise body 502 and a pair of straps 510. Body 502 has a top edge 503, a bottom edge 504, a pair of side edges 505, and an inner surface 506. As shown, body 502 can contain a plurality of pleats disposed between side edges 505. For example, referring to FIG. 5A, body 502 can contain three pleats 507, 508, and 509 evenly disposed between side edges 505, with center pleat 508 centrally disposed between side edges 505. Alternatively, referring to FIG. 5B, body 502 can contain three pleats 507, 508, and 509 that are unevenly disposed between side edges 505, with, for example, center pleat 508 disposed closer to one of the side edges than the other. FIG. 5C-E contain additional exemplary embodiments in which body 502 contains more than three pleats (e.g., five pleats, 507, 508, 509, 515, and 516) disposed between side edges 505. As shown, straps 510 have a first end 511 or 512, which are connected to body 506, and a second end 513 or 514. For example, first ends 511 and 512 are oppositely disposed relative to one another, and can be connected to the body adjacent to top edge 503 (FIG. 5B) or adjacent to bottom edge 503 (FIG. 5C-F). Alternatively, one first end (e.g., 512) can be connected to the body adjacent to top edge 503 and one first end (e.g., 511) can be connected to the body adjacent to bottom edge 504. See, e.g., FIG. 5A. As shown in FIG. 5A, in some embodiments, bottom edge 504 is stretchable between a retracted length and an extended length. See also FIG. 5C and FIG. 5F. But see FIG. 5B, FIG. 5D, and FIG. 5E in which bottom edge 504 is rigid (i.e., not stretchable). As shown in FIG. 5D-F, in some embodiments, face mask 501 can further comprise a malleable stiffening member 517 attached to or within the body at a central location proximate to top edge 503, and extending in a direction substantially perpendicular to the one or more pleats (e.g., 507, 508, 509, 515, and 516). In this way, face mask 501 can readily conform to a wearer's nose (e.g., the bridging portion of a wearer's nose). Further, as would be understood by one of ordinary skill, malleable stiffening member 517 can encourage proper face coverage, preventing the mask from slipping down and exposing the wearer's nose, and ensuring that the mask remains comfortably in place over the wearer's nose. As shown, malleable stiffening member 517 is shorter than top edge 503, such that portions of the top edge (e.g., 518 and 519) are located on either side of malleable stiffening member 517. Alternative arrangements are also envisioned. Each portion 518 and 519 can be stretchable between a retracted length and an extended length (see, e.g., FIG. 5E and FIG. 5F) or can be rigid (i.e., not stretchable; see, e.g., FIG. 5D).

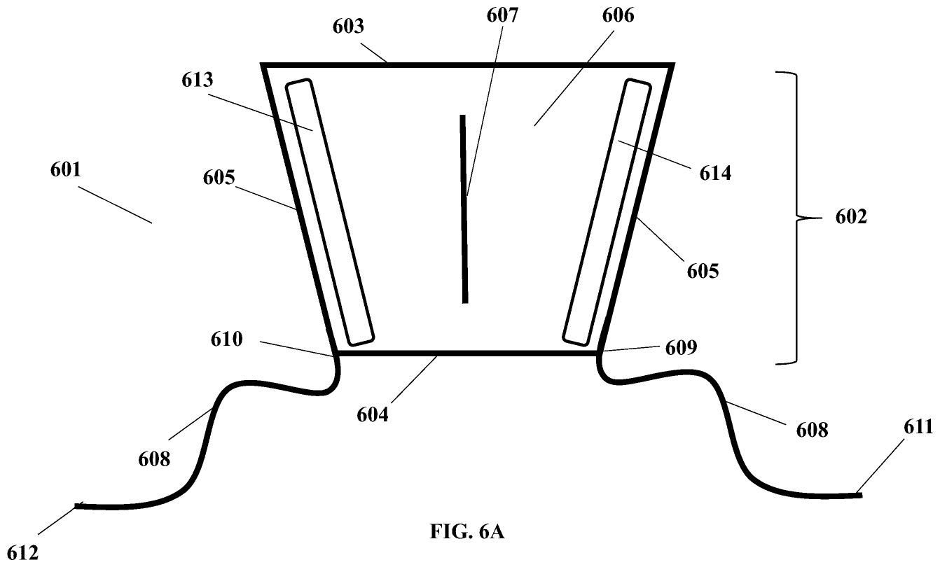

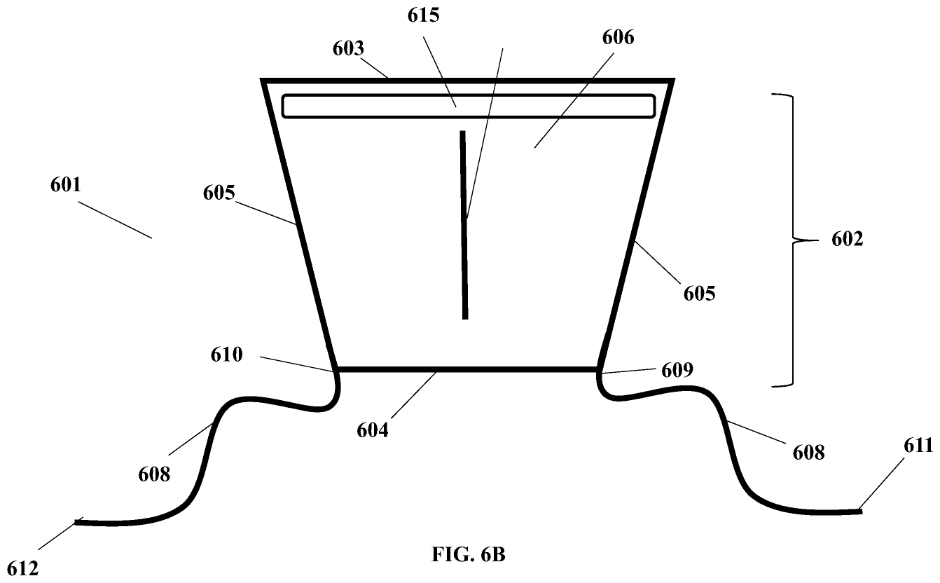

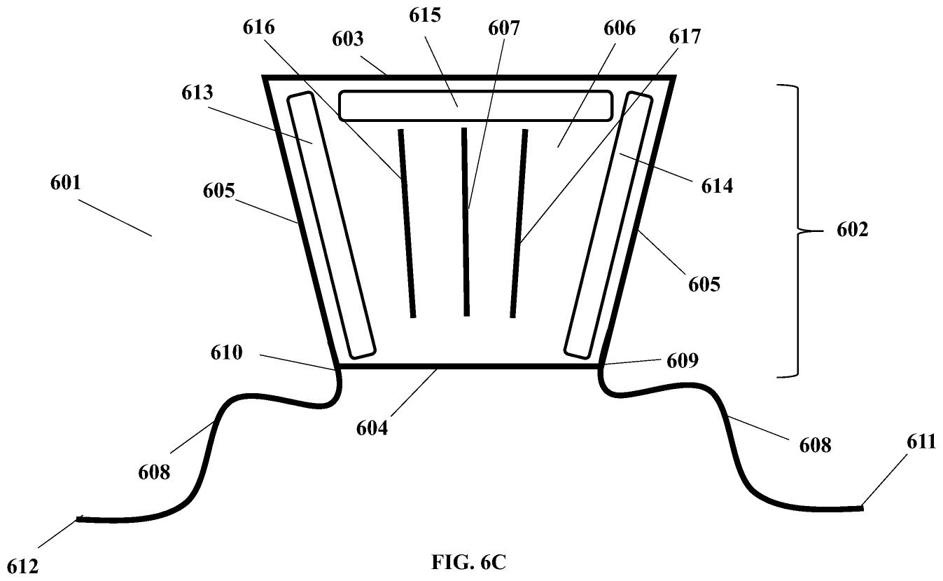

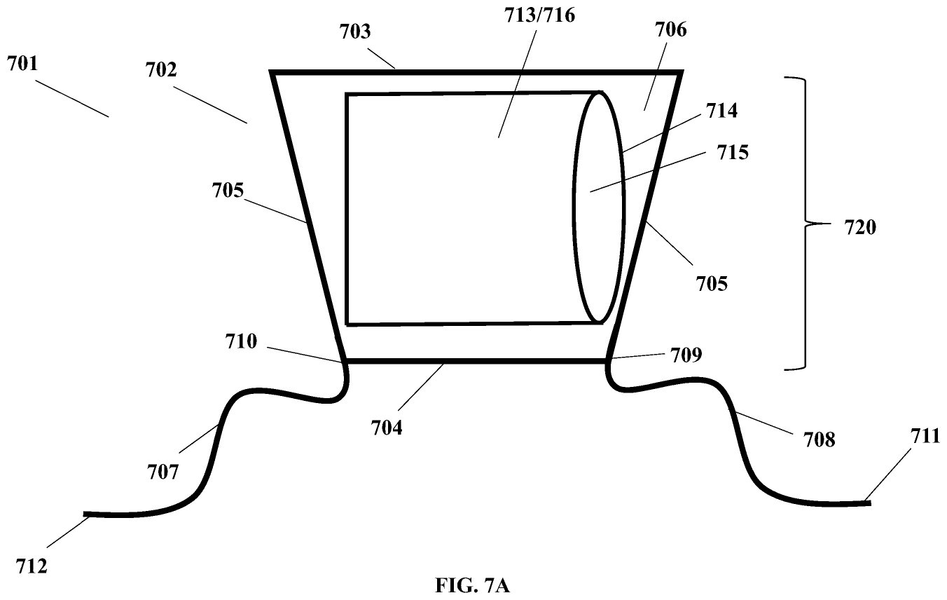

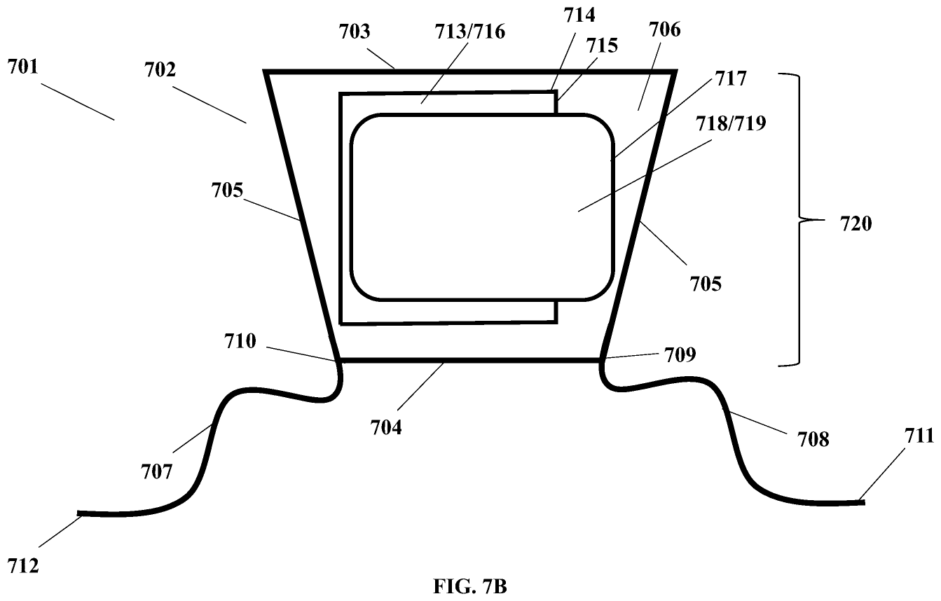

Referring to FIG. 6A-C, for example, face mask 601 can comprise body 602 and a pair of straps 608. Body 602 has a top edge 603, a bottom edge 604, a pair of side edges 605, an inner surface 606, and at least one pleat 607 disposed between side edges 605. The pair of straps 608 are connected to body 602 via first ends 609 and 610. But see second ends 611 and 612. As shown, pleat 607 runs in direction that is substantially parallel to side edges 605. In this way, face mask 601 can expand relative to an x-axis that runs parallel to bottom edge 604, and can therefore readily accommodate a pocket and/or a filter as further described herein. See, e.g., FIG. 7A and FIG. 7B. This configuration also offers improved comfort to the wearer, and, in particular, to the wearer's nose. Exemplary embodiments in which face mask 601 contains one pleat 607 (FIG. 6A and FIG. 6B) and multiple pleats 607, 616, and 617 (FIG. 6C) are shown. In various aspects, inner surface 606 can contain one or more attachment members such as, for example, an attachment member proximate to one of side edges 605 (i.e., attachment member 613), an attachment member proximate to the other of side edges 605 (i.e., attachment member 614), and/or an attachment member proximate to top edge 603 (i.e., attachment member 615).

Referring to FIG. 7A and FIG. 7B, for example, face mask assembly 701 can comprise face mask 702, pocket 713, and filter 716. Pocket 713 can optionally have the structure and features of pocket 302 as disclosed herein, and filter 716 can optionally have the structure and features of filter 305 as disclosed herein. As shown, face mask 701 can comprise body 720 and a pair of straps 707 and 708. Body 720 has a top edge 703, a bottom edge 704, a pair of side edges 705, and an inner surface 706. The pair of straps 707 and 708 are connected to body 720 via first ends 709 and 710. Pocket 713 can comprise side edge 714, which defines opening 715. As shown in FIG. 7A, pocket 713 is attached to inner surface 706 via exterior surface 716. As shown in FIG. 7B, filter 718 comprises a plurality of layers (not shown) joined together at common edge 717, wherein at least one layer is inserted into pocket 713 via opening 715. In this way, the innermost layer (not shown) is located between one face of exterior surface 716 and inner surface 706 and outermost layer 719 is located adjacent to the other face of exterior surface 716. In this way, substantially all of outermost layer 719 is in direct contact with a wearer's face when in use. Should the wearer wish to replace the filter, they need only remove filter 716 from the pocket, and insert a new filter into the pocket. Thus, the mask and pocket beneficially remain clean and clear of contaminants.

Referring to FIG. 8A-D, for example, face mask assembly 826 can comprise face mask 801 and pocket 822. Pocket 822 can optionally have the structure and features of pocket 302 as disclosed herein. FIG. 8A shows a front view of a representative face mask before the pocket is attached. As shown, face mask 801 can comprise body 802 and pair of straps 810. Body 802 has a top edge 803, a bottom edge 804, a pair of side edges 805, an inner surface 806, and five pleats 807, 808, 809, 814, and 815 disposed between side edges 805. Attachment members 819 and 820 are located on inner surface 806, and can be used to secure the pocket to the inner surface of the mask. As shown, bottom edge 804 is stretchable between a retracted length and an extended length. Malleable stiffening member 816 is located proximate to the top edge (e.g., either attached to or near the edge or otherwise secured within the body) such that there is a portion of the top edge (i.e., portions 817 and 818) on each side of malleable stiffening member 816. As shown, portions 817 and 818 are stretchable between a retracted length and an extended length. FIG. 8B shows a front view of a representative face mask with a pocket attached (e.g., reversibly attached via the attachment members; see also FIG. 8A). Pocket 822 has an exterior surface with front face 825 and a back face (not shown) and a side edge 823 that defines opening 824. As shown, the back face of the pocket (not shown) is reversibly attached to inner surface 806 via attachment members 819 and 820, although alternative arrangements are also envisioned. FIG. 8C shows a front view of a representative face mask with a pocket attached (e.g., reversibly attached via the attachment members; see also FIG. 8A), and a filter having a plurality of layers, wherein at least one of the centrally located layers is inserted into the pocket. Filter 828 comprises a plurality of layers (not shown) joined together at common edge 827, wherein at least one layer is inserted into pocket 822 via opening 824. In this way, the innermost layer of the filter (not shown) is located between the back face of the exterior surface of the pocket (not shown) and inner surface 706, and outermost layer 829 is located adjacent to front face 825. FIG. 8D shows a back view of a representative face mask. As shown, the pair of straps 810 are reversibly attached to body 802 via first ends 811 and 812 and attachment members 832 and 833. Second ends 812 and 813 comprise attachment members 830 and 831, which are configured for engagement with attachment members 834 and 835.

In various aspects, the body of the face mask can comprise a breathable fabric. Examples of breathable fabrics include, but are not limited to, cotton, nylon, rayon, linen, muslin, silk, micromodal, chambray, and polyester. In a further aspect, the body consists of one or more breathable fabrics.

In various aspects, the pleat disposed between the side edges of the body of the face mask is centrally disposed between the side edges. In a further aspect, the body comprises a plurality of pleats disposed between the side edges such as, for example, two, three, four, five, six, seven, eight, or more than eight pleats. Without wishing to be bound by theory, the one or more pleats create an expanded fit that can accommodate additional components such as, for example, a filter and a pocket.

In various aspects, the pleat disposed between the side edges of the body of the face mask has a length in a direction parallel to a y-axis as shown in, for example, FIG. 8A-C. Thus, in various aspects, the pleat disposed between the side edges of the body of the face mask has a length of from about 0.25 inches to about 1.5 inches, about 0.25 inches to about 1.25 inches, about 0.25 inches to about 1.0 inch, about 0.25 inches to about 0.75 inches, about 0.25 inches to about 0.50 inches, about 0.50 inches to about 1.5 inches, about 0.75 inches to about 1.5 inches, about 1.0 inch to about 1.5 inches, about 1.25 inches to about 1.5 inches, about 0.50 inches to about 1.25 inches, or about 0.75 inches to about 1.0 inch. In a further aspect, the pleat disposed between the side edges of the body of the face mask has a length of about 1.0 inch.

In various aspects, the bottom edge of the body of the face mask is stretchable between a retracted length and an extended length. Without wishing to be bound by theory, this elasticity can ensure that the face mask fits snugly on a wearer's chin.

In various aspects, the bottom edge of the body of the face mask has a length, for example, an expanded length and an unexpanded length, in a direction parallel to an x-axis as shown in, for example, FIG. 8A-C.

In various aspects, the bottom edge of the body of the face mask has an expanded length of from about 7 inches to about 13 inches, about 7 inches to about 12 inches, about 7 inches to about 11 inches, about 7 inches to about 10 inches, about 7 inches to about 9 inches, about 7 inches to about 8 inches, about 8 inches to about 13 inches, about 9 inches to about 13 inches, about 10 inches to about 13 inches, about 11 inches to about 13 inches, about 12 inches to about 13 inches, about 8 inches to about 12 inches, about 9 inches to about 11 inches, or about 9.5 inches to about 10.5 inches. In a further aspect, the bottom edge of the body of the face mask has an expanded length of about 12.5 inches. In a still further aspect, the bottom edge of the body of the face mask has an expanded length of about 11 inches.

In various aspects, the bottom edge of the body of the face mask has an unexpanded length of from about 3.0 inches to about 7.0 inches, about 3.0 inches to about 6.0 inches, about 3.0 inches to about 5.0 inches, about 3.0 inches to about 4.0 inches, about 4.0 inches to about 7.0 inches, about 5.0 inches to about 7.0 inches, about 6.0 inches to about 7.0 inches, or about 4.0 inches to about 6.0 inches. In a further aspect, the bottom edge of the body of the face mask has an unexpanded length of about 5 inches.

In various aspects, the expanded length and the unexpanded length of the bottom edge of the body of the face mask are the same (i.e., the bottom edge is not stretchable). In various further aspects, the expanded length and the unexpanded length of the bottom edge of the body of the face mask are different (i.e., the bottom edge is stretchable).

In various aspects, the bottom edge of the body of the face mask has an inseam of from about 4.0 inches to about 8.0 inches, about 4.0 inches to about 7.0 inches, about 4.0 inches to about 6.0 inches, about 4.0 inches to about 5.0 inches, about 5.0 inches to about 8.0 inches, about 6.0 inches to about 8.0 inches, about 7.0 inches to about 7.0 inches, or about 5.0 inches to about 7.0 inches. In a further aspect, the bottom edge of the body of the face mask has an inseam of about 6.25 inches.

In various aspects, the top edge of the body of the face mask has a length, for example, an expanded length and an unexpanded length, in a direction parallel to an x-axis as shown in, for example, FIG. 8A-C.

In various aspects, the top edge of the body of the face mask has an expanded length of from about 7 inches to about 13 inches, about 7 inches to about 12 inches, about 7 inches to about 11 inches, about 7 inches to about 10 inches, about 7 inches to about 9 inches, about 7 inches to about 8 inches, about 8 inches to about 13 inches, about 9 inches to about 13 inches, about 10 inches to about 13 inches, about 11 inches to about 13 inches, about 12 inches to about 13 inches, about 8 inches to about 12 inches, about 9 inches to about 11 inches, or about 9.5 inches to about 10.5 inches. In a further aspect, the top edge of the body of the face mask has an expanded length of about 12.5 inches. In a still further aspect, the top edge of the body of the face mask has an expanded length of about 11 inches.

In various aspects, the top edge of the body of the face mask has an unexpanded length of from about 5.0 inches to about 10.0 inches, about 5.0 inches to about 9.0 inches, about 5.0 inches to about 8.0 inches, about 5.0 inches to about 7.0 inches, about 5.0 inches to about 6.0 inches, about 6.0 inches to about 10.0 inches, about 7.0 inches to about 10.0 inches, about 8.0 inches to about 10.0 inches, about 9.0 inches to about 10.0 inches, about 6.0 inches to about 9.0 inches, or about 7.0 inches to about 8.0 inches. In a further aspect, the top edge of the body of the face mask has an unexpanded length of about 7.5 inches.

In various aspects, the expanded length and the unexpanded length of the top edge of the body of the face mask are the same (i.e., the bottom edge is not stretchable). In various further aspects, the expanded length and the unexpanded length of the top edge of the body of the face mask are different (i.e., the bottom edge is stretchable).

In various aspects, the top edge of the body of the face mask has an inseam of from about 4.0 inches to about 8.0 inches, about 4.0 inches to about 7.0 inches, about 4.0 inches to about 6.0 inches, about 4.0 inches to about 5.0 inches, about 5.0 inches to about 8.0 inches, about 6.0 inches to about 8.0 inches, about 7.0 inches to about 7.0 inches, or about 5.0 inches to about 7.0 inches. In a further aspect, the top edge of the body of the face mask has an inseam of about 6.0 inches.

In various aspects, each side edge of the body of the face mask has a width, for example, an expanded width and an unexpanded width, in a direction parallel to a y-axis as shown in, for example, FIG. 8A-C.

In various aspects, each side edge of the body of the face mask has an expanded width of from about 4.0 inches to about 8.0 inches, about 4.0 inches to about 7.0 inches, about 4.0 inches to about 6.0 inches, about 4.0 inches to about 5.0 inches, about 5.0 inches to about 8.0 inches, about 6.0 inches to about 8.0 inches, about 7.0 inches to about 8.0 inches, about 5.0 inches to about 7.0 inches, or about 5.5 inches to about 6.5 inches. In a further aspect, each side edge of the body of the face mask has an expanded width of about 7.0 inches. In a still further aspect, each side edge of the body of the face mask has an expanded width of about 5.0 inches.

In various aspects, each side edge of the body of the face mask has an unexpanded width of from about 4.0 inches to about 8.0 inches, about 4.0 inches to about 7.0 inches, about 4.0 inches to about 6.0 inches, about 4.0 inches to about 5.0 inches, about 5.0 inches to about 8.0 inches, about 6.0 inches to about 8.0 inches, about 7.0 inches to about 8.0 inches, about 5.0 inches to about 7.0 inches, or about 5.5 inches to about 6.5 inches. In a further aspect, each side edge of the body of the face mask has an unexpanded width of about 7.0 inches. In a still further aspect, each side edge of the body of the face mask has an unexpanded width of about 5.0 inches.

In various aspects, the expanded length and the unexpanded length of each side edge of the body of the face mask are the same (i.e., the side edges are not stretchable). In various further aspects, the expanded length and the unexpanded length of each side edge of the body of the face mask are different (i.e., the side edges are stretchable).

In various aspects, each side edge of the body of the face mask has an inseam of from about 0.25 inches to about 1.5 inches, about 0.25 inches to about 1.25 inches, about 0.25 inches to about 1.0 inch, about 0.25 inches to about 0.75 inches, about 0.25 inches to about 0.50 inches, about 0.50 inches to about 1.5 inches, about 0.75 inches to about 1.5 inches, about 1.0 inch to about 1.5 inches, about 1.25 inches to about 1.5 inches, about 0.50 inches to about 1.25 inches, or about 0.75 inches to about 1.0 inch. In a further aspect, each side edge of the body of the face mask has an inseam of about 0.75 inches.

In various aspects, each first end of each strap on the face mask is connected to the body adjacent to the bottom edge. In a further aspect, each first end of each strap on the face mask is connected to the body adjacent to the top edge.

In various aspects, the pair of straps has a second end connected to the body adjacent to the top edge, wherein each second end is oppositely disposed relative to one another.

In various aspects, each strap has a length of from about 10 inches to about 25 inches, about 10 inches to about 20 inches, about 10 inches to about 15 inches, about 15 inches to about 25 inches, about 20 inches to about 25 inches, or about 15 inches to about 20 inches. In a further aspect, each strap has a length of about 16.5 inches.

In various aspects, the face mask has an exterior surface, the pair of straps has a second end, each second end comprises a first attachment member configured for engagement with a second attachment member located on the exterior surface of the face mask adjacent to the top edge, and wherein each second attachment member is oppositely disposed relative to one another. In a still further aspect, each second end configures a first attachment member configured for engagement with a second attachment member located adjacent to the bottom edge, and wherein each second attachment member is oppositely disposed relative to one another. Examples of attachment members include, but are not limited to, buckles, hook-and-loop fasteners, rings, clips, carabiners, swivel-hooks, snaps, snap-hooks, bulldog clips, trigger hooks, tape, tack, self-adherent wrap, and hooks. In a further aspect, the first and second attachment members are hook-and-loop fasteners. Each second end of each strap can then be reversibly attached to the face mask via the first and second attachment members. Without being bound by theory, this allows the straps to be adjusted to fit comfortably and snugly on a wearer.

In various aspects, the face mask further comprises a malleable stiffening member attached to or within the body at a central location proximate to the top edge, extending in a direction perpendicular to the pleat, and configured to conform the body to a wearer's nose. Without wishing to be bound by theory, the malleable stiffening member can ensure that the face mask fits snugly on a wearer's nose. In a further aspect, the malleable stiffening member has a pair of opposing sides, wherein the malleable stiffening member is shorter than the top edge, such that there is a portion of the top edge on each side of the malleable stiffening member. In a still further aspect, each portion of the top edge is stretchable between a retracted length and an extended length. Without wishing to be bound by theory, this elasticity can ensure that the face mask fits snufly on a wearer's cheeks.

In various aspects, the malleable stiffening member has a length in a direction parallel to an x-axis as shown in, for example, FIG. 8A-C.

In various aspects, the malleable stiffening member has a length of from about 0.5 inches to about 4.0 inches, about 0.5 inches to about 3.0 inches, about 0.5 inches to about 2.0 inches, about 0.5 inches to about 1.0 inch, about 1.0 inch to about 4.0 inches, about 2.0 inches to about 4.0 inches, about 3.0 inches to about 4.0 inches, or about 1.0 inch to about 3.0 inches. In a further aspect, the malleable stiffening member has a length of about 2.0 inches.

In various aspects, each portion of the top edge has a length, for example, an expanded length and an unexpanded length, in a direction parallel to an x-axis as shown in, for example, FIG. 8A-C.

In various aspects, each portion of the top edge has an unexpanded length of from about 2.0 inches to about 6.0 inches, about 2.0 inches to about 5.0 inches, about 2.0 inches to about 4.0 inches, about 2.0 inches to about 3.0 inches, about 3.0 inches to about 6.0 inches, about 4.0 inches to about 6.0 inches, about 5.0 inches to about 6.0 inches, or about 3.0 inches to about 5.0 inches. In a further aspect, each portion of the top edge has an unexpanded length of about 4.5 inches.

In various aspects, the expanded length and the unexpanded length of each portion of the top edge are the same (i.e., the portions of the top edge are not stretchable). In various further aspects, the expanded length and the unexpanded length of each portion of the top edge are different (i.e., the portions of the top edge are stretchable).

In various aspects, the inner surface of the body comprises an attachment member. In a further aspect, the inner surface of the body comprises a pair of attachment members, wherein one attachment member is proximate to one side edge of the body, and wherein the other attachment member is proximate to the other side edge of the body. In a still further aspect, the attachment member is proximate to the top edge of the body. In yet a further aspect, the attachment member is proximate to the top edge of the body and to each side edge of the body. Examples of attachment members include, but are not limited to, buckles, hook-and-loop fasteners, rings, clips, carabiners, swivel-hooks, snaps, snap-hooks, bulldog clips, trigger hooks, tape, tack, self-adherent wrap, and hooks. In a further aspect, each attachment member is a hook-and-loop fastener. In a still further aspect, each attachment member is self-adherent wrap, such as, for example, Curad® self-adherent wrap. Without wishing to be bound by theory, the attachment member on the inner surface of the body can be used to secure a pocket and/or a filter to the face mask. Further, as would be appreciated by one of ordinary skill in the art, the attachment member should be selected to maximize comfort of the wearer, and also to ensure that the mask can remain flush against a wearer's face.

In various aspects, the pocket is reversibly attached to the inner surface of the face mask. In a still further aspect, the pocket is reversibly attached via hook-and-loop fasteners, tape, self-adherent wrap, or tack. In yet a further aspect, the pocket is reversibly attached via self-adherent wrap. In an even further aspect, the pocket is reversibly attached via hook-and-loop fasteners located on the pocket that are configured for engagement with hook-and-loop fasteners located on the face mask. In a still further aspect, the pocket is reversibly attached via self-adherent wrap located on both the pocket and on the face mask. In yet a further aspect, the pocket has an exterior surface, and the reversible attachment members (e.g., hook-and-loop fasteners, tape, self-adherent wrap) are located on the exterior surface of the pocket and on the inner surface of the face mask.

In various aspects, the pocket is fixedly attached to the inner surface of the face mask. In a further aspect, the pocket is fixedly attached via a seam.

### C. Methods of Making a Filter, Filter Assembly, Face Mask, or Face Mask Assembly

In one aspect, disclosed are methods of making a filter. In a further aspect, the method comprises joining together at least two layers of material at a common edge, wherein each layer consists of material configured to refine air contaminants, and wherein each layer is dimensioned in size to fit over the nose and mouth of a wearer (e.g., an adult wearer or a child wearer). In a still further aspect, the method comprises joining together at least three layers of material at a common edge. In yet a further aspect, the method comprises joining together exactly three layers of material at a common edge. In an even further aspect, the method does not comprise joining each layer together at an opposing edge that is oppositely disposed relative to the common edge.

In various aspects, the filter can comprise a plurality of layers, as further described herein, wherein each layer is joined together at a common edge, and wherein each layer is not joined together at an opposing edge that is oppositely disposed relative to the common edge. In a further aspect, the filter comprises exactly two layers. In a still further aspect, the filter comprises more than two layers. In yet a further aspect, the filter comprises exactly three layers. In an even further aspect, the filter comprises more than three layers.

In various aspects, the filter can comprise exactly three layers, wherein a second layer is dispersed between a first and a third layer, wherein each layer is joined together at a common edge, and wherein the filter consists of material configured to refine contaminants.

In various aspects, each layer can be joined together via a seam. In a further aspect, each layer can be joined together via glue. In a still further aspect, each layer can be joined together via tape, tack, or self-adherent wrap.

In one aspect, disclosed are methods of making a filter assembly. In a further aspect, the method comprises inserting a layer of a disclosed filter into a pocket having a side edge that defines an opening, wherein the layer of the filter is inserted via the opening.

In various aspects, the filter assembly can comprise: (a) a pocket having a side edge that defines an opening; and (b) a filter comprising a plurality of layers, wherein each layer is joined together at a common edge, and wherein at least one layer is configured for insertion into the pocket via the opening.

In various aspects, the filter assembly can comprise: (a) a pocket consisting of one or more breathable materials, and having a side edge that defines an opening; and (b) a filter comprising exactly three layers, wherein each layer is joined together at a common edge, wherein each layer is not joined together at an opposing edge that is oppositely disposed relative to the common edge, wherein a second layer is dispersed between a first and a third layer, and wherein the second layer is configured for insertion into the pocket via the opening.

Referring to FIG. 3A for example, the insertion can be accomplished by placing filter 305 onto a clean, flat surface, such that substantially all of the exterior face of layer 306 is in direct contact with the clean, flat surface, and the exterior surface of layer 308 is facing upwards. As further illustrated in FIG. 3B-E, upwards facing layer 308 is the same face that contains attachment members 313, 314, and 315, when present, which can be used to secure the filter to the mask. Layer 308 is then folded back to expose the middle layer(s) (e.g., 307). Middle layer 307 can then be folded down diagonally from the top edge of layer 307 until the tip of the top edges touches the bottom edge of layer 307, thereby forming a triangle. While holding middle layer 307 folded down, pocket 302 should be opened, and middle layer 307 inserted via opening 304. At this time, the folded edge can be released and smoothed down until layer 307 lies flat within pocket 302. Layers 308 and 306 can then be folded down, thereby covering both front face 311 and back face 312 of pocket 302.

In one aspect disclosed are methods of making a face mask. In a further aspect, the method comprises attaching a first end of each member of a pair of straps to a body having a top edge, a bottom edge, a pair of side edges, an exterior surface, and an opposed inner surface configured to be worn against a wearer's face, wherein the body comprises a pleat disposed between the side edges. In a further aspect, each first end is attached to the exterior surface of the face mask adjacent to the bottom edge, wherein each first end is oppositely disposed relative to one another. In a still further aspect, each first end is attached to the exterior surface of the face mask adjacent to the top edge, wherein each first end is oppositely disposed relative to one another. In yet a further aspect, each first end is attached to the interior surface of the face mask adjacent to the bottom edge, wherein each first end is oppositely disposed relative to one another. In an even further aspect, each first end is attached to the exterior surface of the face mask adjacent to the top edge, wherein each first end is oppositely disposed relative to one another.

In various aspects, the face mask can comprise: (a) a body having a top edge, a bottom edge, a pair of side edges, and an inner surface configured to be worn against a wearer's face, wherein the body comprises a pleat disposed between the side edges; and (b) a pair of straps having a first end connected to the body adjacent to the top edge or adjacent to the bottom edge, and wherein each first end is oppositely disposed relative to one another.

In one aspect, the face mask can comprise: (a) a body consisting of a breathable material, and having a top edge, a bottom edge, a pair of side edges, and an inner surface configured to be worn against a wearer's face, wherein the body comprises a plurality of pleats disposed between the side edges, and wherein the bottom edge of the body is stretchable between a retracted length and an extended length; and (b) a pair of straps having a first end and a second end, wherein each first end is connected to the body adjacent to the bottom edge of the body, wherein each first end is oppositely disposed relative to one another, wherein each second end comprises a first attachment member configured for engagement with a second attachment member located adjacent to the top edge of the body, and wherein each second attachment member is oppositely disposed relative to one another.

In various aspects, each first end is fixedly attached to the body by, for example, a seam. In a further aspect, each first end is reversibly attached to the body by, for example, hook-and-loop fasteners, tape, or self-adherent wrap.

In various aspects, the method further comprises attaching a second end of each member of the pair of straps to the body. In a further aspect, each second end is attached to the exterior surface of the face mask adjacent to the top edge, wherein each second end is oppositely disposed relative to one another. In a still further aspect, each second end is attached to the exterior surface of the face mask adjacent to the top edge, each second end is oppositely disposed relative to one another. In yet a further aspect, each second end is attached to the interior surface of the face mask adjacent to the bottom edge, wherein each second end is oppositely disposed relative to one another. In an even further aspect, each second end is attached to the exterior surface of the face mask adjacent to the top edge, wherein each second end is oppositely disposed relative to one another.

In various aspects, each second end is fixedly attached to the body by, for example, a seam. In a further aspect, each second end is reversibly attached to the body by, for example, hook-and-loop fasteners, tape, or self-adherent wrap.

In one aspect, disclosed are methods of making a face mask assembly. In a further aspect, the method comprises attaching a pocket having a side edge that defines an opening to the inner surface of a face mask. In a further aspect, attaching is fixedly attaching (e.g., via a seam). In a still further aspect, attaching is reversibly attaching (e.g., via hook-and-loop fasteners, tape, self-adherent wrap) as further described herein. For example, in various aspects, the attachment members (e.g., hook-and-loop fasteners, tape, self-adherent wrap) can be located on the exterior surface of the pocket and on the inner surface of the face mask.

In various aspects, the face mask assembly can comprise a disclosed face mask, and a pocket having a side edge that defines an opening, wherein the pocket is attached to the inner surface of the face mask.

In various aspects, the face mask assembly can comprise: (a) a disclosed face mask; (b) a pocket having an exterior surface with a front face and a back face, and a side edge that defines an opening, wherein the pocket is attached to the inner surface of the face mask; and (c) a filter comprising exactly three layers, wherein each layer is joined together at a common edge, wherein each layer is not joined together at an opposing edge that is oppositely disposed relative to the common edge, wherein a second layer is dispersed between a first and a third layer, and wherein the second layer is configured for insertion into the pocket via the opening such that the second layer, when inserted, is separated from the first layer by the front face of the pocket and from the third layer by the back face of the pocket, and the first layer is between the inner surface of the body of the face mask and the back face of the exterior surface of the pocket.

In various aspects, the method further comprises inserting a layer of a disclosed filter into the pocket via the opening.

Referring to FIG. 3B-E for example, attachment member 316 can be used to attach the pocket to the inner surface of the face mask. See also FIG. 8A and FIG. 8B, illustrating attachment of pocket 822 to inner surface 806. For example, attachment member 316 can be used to attach the pocket adjacent to the top edge and to one side edge of the face mask. Alternatively, pocket 822 can be attached to inner surface 806 via attachment members on inner surface 806 (e.g., 819, 820).

In various aspects, the filter is inserted into the pocket, thereby forming a filter assembly, prior to attachment to a face mask. Thus, referring to FIG. 3B-E for example, attachment member 316 can be used to attach the pocket to the inner surface of the face mask. The filter assembly can then be further attached to the inner surface of the face mask via the attachment members on the layer 308 (e.g., 314, 315, 316). As would be readily understood by one of skill in the art, the filter assembly should be snugly fitted to the face mask by, for example, pressing firmly on all sides of the filter assembly.

In various aspects, the pocket is attached to the face mask prior to insertion of the filter. See, e.g., FIG. 8A-D.

Once the face mask assembly is in place, the mask can be folded in half in a direction parallel to the pleats before being opened slightly and placed over a wearer's face. As would be understood by one of skill in the art, the malleable stiffening member (e.g., a nose guard or nose guide) should be fitted over the nose, thereby covering the wearer's nose and mouth. The straps can be then be attached by, for example, crossing in an X-shape behind the neck and securing to additional attachment members on the face mask. Alternative means of putting on a face mask and of securing the straps would be understood by one of skill in the art, and are also disclosed elsewhere herein.

### D. Kits

In one aspect, disclosed are kits comprising a disclosed face mask, and one or more selected from: (a) a pocket having a side edge that defines an opening; (b) a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening; (c) a filter layer comprising a pair of opposing side edges, a pair of opposing side edges, an adhesive strip, and a removable liner covering the adhesive strip, wherein the adhesive strip is adjacent to one of the side edges and runs in a direction parallel to that side edge; (d) instructions for attaching a pocket to a face mask; (e) instructions for inserting a filter into a pocket; and (f) instructions for replacing a filter.

In various aspects, the face mask can comprise: (a) a body having a top edge, a bottom edge, a pair of side edges, and an inner surface configured to be worn against a wearer's face, wherein the body comprises a pleat disposed between the side edges; and (b) a pair of straps having a first end connected to the body adjacent to the top edge or adjacent to the bottom edge, and wherein each first end is oppositely disposed relative to one another.

In various aspects, the face mask can comprise: (a) a body consisting of a breathable material, and having a top edge, a bottom edge, a pair of side edges, and an inner surface configured to be worn against a wearer's face, wherein the body comprises a plurality of pleats disposed between the side edges, and wherein the bottom edge of the body is stretchable between a retracted length and an extended length; and (b) a pair of straps having a first end and a second end, wherein each first end is connected to the body adjacent to the bottom edge of the body, wherein each first end is oppositely disposed relative to one another, wherein each second end comprises a first attachment member configured for engagement with a second attachment member located adjacent to the top edge of the body, and wherein each second attachment member is oppositely disposed relative to one another.

In one aspect, disclosed are kits comprising a pocket having a side edge that defines an opening, and one or more selected from: (a) a face mask; (b) a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening; (c) a filter layer comprising a pair of opposing side edges, a pair of opposing side edges, an adhesive strip, and a removable liner covering the adhesive strip, wherein the adhesive strip is adjacent to one of the side edges and runs in a direction parallel to that side edge; (d) instructions for attaching a pocket to a face mask; (e) instructions for inserting a filter into a pocket; and (f) instructions for replacing a filter.

In one aspect, disclosed are kits comprising a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening, and one or more selected from: (a) a face mask; (b) a pocket having a side edge that defines an opening; (c) a filter layer comprising a pair of opposing side edges, a pair of opposing side edges, an adhesive strip, and a removable liner covering the adhesive strip, wherein the adhesive strip is adjacent to one of the side edges and runs in a direction parallel to that side edge; (d) instructions for attaching a pocket to a face mask; (e) instructions for inserting a filter into a pocket; and (f) instructions for replacing a filter.

In various aspects, the filter layer has a length in a direction parallel to an x-axis as shown in, for example, FIG. 8A-C.

In various aspects, the filter layer has a length of from about 5.0 inches to about 10.0 inches, about 5.0 inches to about 9.0 inches, about 5.0 inches to about 8.0 inches, abut 5.0 inches to about 7.0 inches, about 5.0 inches to about 6.0 inches, about 6.0 inches to about 10.0 inches, about 7.0 inches to about 10.0 inches, about 8.0 inches to about 10.0 inches, about 9.0 inches to about 10.0 inches, about 6.0 inches to about 9.0 inches, or about 7.0 inches to about 8.0 inches. In a further aspect, the filter has a length of about 7.75 inches.

In various aspects, the filter layer has a width in a direction parallel to a y-axis as shown in, for example, FIG. 8A-C.

In various aspects, the filter layer has a width of from about 2.0 inches to about 6.0 inches, about 2.0 inches to about 5.0 inches, about 2.0 inches to about 4.0 inches, about 2.0 inches to about 3.0 inches, about 3.0 inches to about 6.0 inches, about 4.0 inches to about 6.0 inches, about 5.0 inches to about 6.0 inches, about 3.0 inches to about 5.0 inches, or about 3.5 inches to about 4.5 inches. In a further aspect, the filter layer has a width of about 4.0 inches.

### E. Exemplary Aspects

In view of the described devices and methods and variations thereof, herein below are described certain more particularly described aspects of the invention. These particularly recited aspects should not, however, be interpreted to have any limiting effect on any different claims containing different or more general teachings described herein, or that the “particular” aspects are somehow limited in some way other than the inherent meanings of the language literally used therein.

Aspect 1: A filter comprising a plurality of layers, wherein each layer is joined together at a common edge.

Aspect 2: The filter of aspect 1, wherein the filter comprises exactly two layers.

Aspect 3: The filter of aspect 1, wherein the filter comprises more than two layers.

Aspect 4: The filter of aspect 1, wherein the filter comprises exactly three layers.

Aspect 5: The filter of aspect 1, wherein the filter comprises three layers, and wherein a second layer is dispersed between a first and a third layer.

Aspect 6: The filter of aspect 5, wherein the first, second, and third layers are the only layers in the filter.

Aspect 7: The filter of any one of the preceding aspects, wherein the filter consists of material configured to refine air contaminants.

Aspect 8: The filter of aspect 7, wherein the filter comprises paper, cotton, or muslin.

Aspect 9: The filter of aspect 7, wherein the filter comprises paper.

Aspect 10: The filter of aspect 7, wherein the filter consists of paper.

Aspect 11: A filter comprising exactly three layers, wherein a second layer is dispersed between a first and a third layer, wherein each layer is joined together at a common edge, and wherein the filter consists of material configured to refine air contaminants.

Aspect 12: A filter assembly comprising: (a) a pocket having a side edge that defines an opening; and (b) a filter comprising a plurality of layers, wherein each layer is joined together at a common edge, and wherein at least one layer is configured for insertion into the pocket via the opening.

Aspect 13: The filter assembly of aspect 12, wherein the pocket comprises a breathable fabric.

Aspect 14: The filter assembly of aspect 13, wherein the breathable fabric is cotton, nylon, rayon, linen, muslin, silk, micromodal, chambray, or polyester.

Aspect 15: The filter assembly of any one of the preceding aspects, wherein the pocket consists of one or more breathable fabrics.

Aspect 16: The filter assembly of any one of the preceding aspects, wherein the filter comprises exactly three layers.

Aspect 17: The filter assembly of any one of the preceding aspects, wherein one layer is configured for insertion into the pocket via the opening.

Aspect 18: The filter assembly of any one of aspects 12 to 16, wherein more than one layer is configured for insertion into the pocket via the opening.

Aspect 19: The filter assembly of any one of the preceding aspects, wherein the filter comprises three layers, wherein a second layer is dispersed between a first and a third layer, and wherein the second layer is configured for insertion into the pocket via the opening.

Aspect 20: The filter assembly of aspect 19, wherein the first, second, and third layers are the only layers in the filter.

Aspect 21: The filter assembly of aspect 19, wherein the pocket has an exterior surface with a front face and a back face, wherein the second layer is inserted into the pocket via the opening, wherein the first layer is separated from the second layer by the front face of the pocket, and wherein the third layer is separated from the second layer by the back face of the pocket.

Aspect 22: The filter assembly of any one of the preceding aspects, further comprising an attachment member proximate to the common edge of the filter.

Aspect 23: The filter assembly of aspect 22, wherein the attachment member is hook-and-loop fasteners, tape, or tack.

Aspect 24: The filter assembly of aspect 22, wherein the attachment member is tape.

Aspect 25: The filter assembly of any one of the preceding aspects, wherein each layer of the filter comprises a pair of opposing sides, wherein one side of each layer together comprise the common edge, and wherein the other side of at least one layer comprises an attachment member.

Aspect 26: The filter assembly of any one of the preceding aspects, wherein each layer of the filter comprises a pair of opposing sides, wherein one side of each layer together comprise the common edge, and wherein the filter further comprises a pair of attachment members, wherein one attachment member proximate to the common edge, and wherein the other attachment member on the other side of at least one layer.

Aspect 27: A filter assembly comprising: (a) a pocket consisting of one or more breathable materials, and having a side edge that defines an opening; and (b) a filter comprising exactly three layers, wherein each layer is joined together at a common edge, wherein a second layer is dispersed between a first and a third layer, and wherein the second layer is configured for insertion into the pocket via the opening.

Aspect 28: A face mask comprising: (a) a body having a top edge, a bottom edge, a pair of side edges, and an inner surface configured to be worn against a wearer's face, wherein the body comprises a pleat disposed between the side edges; and (b) a pair of straps having a first end connected to the body adjacent to the top edge or adjacent to the bottom edge, and wherein each first end is oppositely disposed relative to one another.

Aspect 29: The face mask of aspect 28, wherein the body comprises a breathable fabric.

Aspect 30: The face mask of aspect 29, wherein the breathable fabric is cotton, nylon, rayon, linen, muslin, silk, micromodal, chambray, or polyester.

Aspect 31: The face mask of any one of the preceding aspects, wherein the body consists of one or more breathable fabrics.

Aspect 32: The face mask of any one of the preceding aspects, wherein the pleat is centrally disposed between the side edges.

Aspect 33: The face mask of any one of the preceding aspects, wherein the body comprises a plurality of pleats disposed between the side edges.

Aspect 34: The face mask of any one of the preceding aspects, wherein the bottom edge of the body is stretchable between a retracted length and an extended length.

Aspect 35: The face mask of any one of the preceding aspects, wherein each first end is connected to the body adjacent to the bottom edge.

Aspect 36: The face mask of aspect 35, wherein the pair of straps has a second end connected to the body adjacent to the top edge, and wherein each second end is oppositely disposed relative to one another.

Aspect 37: The face mask of aspect 35, wherein the pair of straps has a second end, wherein each second end comprises a first attachment member configured for engagement with a second attachment member located adjacent to the top edge, and wherein each second attachment member is oppositely disposed relative to one another.

Aspect 38: The face mask of aspect 37, wherein the first and second attachment members are hook-and-loop fasteners.

Aspect 39: The face mask of any one of the preceding aspects, wherein the face mask further comprises a malleable stiffening member attached to or within the body at a central location proximate to the top edge, extending in a direction perpendicular to the pleat, and configured to conform the body to a wearer's nose.

Aspect 40: The face mask of aspect 39, wherein the malleable stiffening member has a pair of opposing sides, and wherein the malleable stiffening member is shorter than the top edge, such that there is a portion of the top edge on each side of the malleable stiffening member.

Aspect 41: The face mask of aspect 40, wherein each portion of the top edge is stretchable between a retracted length and an extended length.

Aspect 42: The face mask of any one of the preceding aspects, wherein the inner surface of the body comprises an attachment member.

Aspect 43: The face mask of aspect 42, wherein the inner surface of the body comprises a pair of attachment members, and wherein one attachment member is proximate to one side edge of the body, and wherein the other attachment member is proximate to the other side edge of the body.

Aspect 44: The face mask of aspect 42, wherein the attachment member is proximate to the top edge of the body.

Aspect 45: The face mask of aspect 42, wherein the attachment member is proximate to the top edge of the body and to each side edge of the body.

Aspect 46: The face mask of aspect 42, wherein the attachment member is hook-and-loop fasteners.

Aspect 47: A kit comprising the face mask aspect [00184], and one or more selected from: (a) a pocket having a side edge that defines an opening; (b) a filter comprising a plurality of layers, wherein each layer is joined together at a common edge, and wherein at least one layer is configured for insertion into the pocket via the opening; (c) instructions for attaching a pocket to a face mask; (d) instructions for inserting a filter into a pocket; and € instructions for replacing a filter.

Aspect 48: A face mask assembly comprising the face mask of aspect [00184], and a pocket having a side edge that defines an opening, wherein the pocket is attached to the inner surface of the face mask.

Aspect 49: The face mask assembly of aspect 48, wherein the pocket is reversibly attached to the inner surface of the face mask.

Aspect 50: The face mask assembly of aspect 49, wherein the pocket is reversibly attached via hook-and-loop fasteners, tape, or tack.

Aspect 51: The face mask assembly of aspect 49, wherein the pocket is reversibly attached via hook-and-loop fasteners located on the pocket that are configured for engagement with hook-and-loop fasteners located on the face mask.

Aspect 52: The face mask assembly of aspect 50, wherein the pocket has an exterior surface, and wherein the hook-and-loop fasteners are located on the exterior surface of the pocket and on the inner surface of the face mask.

Aspect 53: The face mask assembly of aspect 48, wherein the pocket is fixedly attached to the inner surface of the face mask.

Aspect 54: The face mask assembly of aspect 53, wherein the pocket is fixedly attached via a seam.

Aspect 55: A kit comprising the face mask assembly of aspect 48, and one or more selected from: (a) a filter comprising a plurality of layers, wherein each layer is joined together at a common edge, and wherein at least one layer is configured for insertion into the pocket via the opening; (b) instructions for attaching a pocket to a face mask; (c) instructions for inserting a filter into a pocket; and (d) instructions for replacing a filter.

Aspect 56: A face mask assembly comprising: (a) the face mask of aspect [00184]; (b) a pocket having an exterior surface with a front face and a back face, and a side edge that defines an opening, wherein the pocket is attached to the inner surface of the face mask; and (c) a filter comprising exactly three layers, wherein each layer is joined together at a common edge, wherein a second layer is dispersed between a first and a third layer, and wherein the second layer is configured for insertion into the pocket via the opening such that the second layer, when inserted, is separated from the first layer by the front face of the pocket and from the third layer by the back face of the pocket, and the first layer is between the inner surface of the body of the face mask and the back face of the exterior surface of the pocket.

Aspect 57: A face mask comprising: (a) a body consisting of a breathable material, and having a top edge, a bottom edge, a pair of side edges, and an inner surface configured to be worn against a wearer's face, wherein the body comprises a plurality of pleats disposed between the side edges, and wherein the bottom edge of the body is stretchable between a retracted length and an extended length; and (b) a pair of straps having a first end and a second end, wherein each first end is connected to the body adjacent to the bottom edge of the body, wherein each first end is oppositely disposed relative to one another, wherein each second end comprises a first attachment member configured for engagement with a second attachment member located adjacent to the top edge of the body, and wherein each second attachment member is oppositely disposed relative to one another.

Aspect 58: A face mask assembly comprising the face mask of aspect 57, and a pocket having a side edge that defines an opening, wherein the pocket is attached to the inner surface of the face mask.

Aspect 59: A face mask assembly comprising: (a) the face mask of aspect 57; (b) a pocket having an exterior surface with a front face and a back face, and a side edge that defines an opening, wherein the pocket is attached to the inner surface of the face mask; and (c) a filter comprising exactly three layers, wherein each layer is joined together at a common edge, wherein a second layer is dispersed between a first and a third layer, and wherein the second layer is configured for insertion into the pocket via the opening such that the second layer, when inserted, is separated from the first layer by the front face of the pocket and from the third layer by the back face of the pocket, and the first layer is between the inner surface of the body of the face mask and the back face of the exterior surface of the pocket.

Aspect 60: A kit comprising a pocket having a side edge that defines an opening, and one or more selected from: (a) a face mask; (b) a filter comprising a plurality of layers, wherein each layer is joined together at a common edge, and wherein at least one layer is configured for insertion into the pocket via the opening; (c) instructions for attaching a pocket to a face mask; (d) instructions for inserting a filter into a pocket; and (e) instructions for replacing a filter.

Aspect 61: A kit comprising a filter comprising a plurality of layers, wherein each layer is joined together at a common edge, and wherein at least one layer is configured for insertion into the pocket via the opening, and one or more selected from: (a) face mask; (b) a pocket having a side edge that defines an opening; (c) instructions for attaching a pocket to a face mask; (d) instructions for inserting a filter into a pocket; and (e) instructions for replacing a filter.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A filter comprising a plurality of layers, wherein each layer is joined together at a common edge, wherein each layer is not joined together at an opposing edge that is oppositely disposed relative to the common edge.

2. The filter of claim 1, wherein each layer has an interior surface, and wherein each layer is not joined together at the interior surface.

3. The filter of claim 1, wherein the filter comprises exactly two layers.

4. The filter of claim 1, wherein the filter comprises more than two layers.

5. The filter of claim 1, wherein the filter comprises exactly three layers.

6. The filter of claim 1, wherein the filter comprises first, second, and third layers, and wherein the second layer is dispersed between the first layer and the third layer.

7. The filter of claim 6, wherein the first, second, and third layers are the only layers in the filter.

8. The filter of claim 1, wherein the filter consists of material configured to refine air contaminants.

9. The filter of claim 8, wherein the filter comprises paper, cotton, or muslin.

10. The filter of claim 8, wherein the filter comprises paper.

11. The filter of claim 8, wherein the filter consists of paper.

12. The filter of claim 1, wherein one or more layers has a perforation adjacent to the common edge that runs in a direction parallel to the common edge.

13. A filter comprising exactly three layers, wherein a second layer of the filter is dispersed between a first layer and a third layer of the filter, wherein each layer is joined together at a common edge, wherein each layer is not joined together at an opposing edge that is oppositely disposed relative to the common edge, and wherein the filter consists of material configured to refine air contaminants.

14. A filter assembly comprising:
(a) a pocket having a side edge that defines an opening; and
(b) a filter comprising a plurality of layers, wherein each layer is joined together at a common edge, wherein each layer is not joined together at an opposing edge that is oppositely disposed relative to the common edge, and wherein at least one layer is configured for insertion into the pocket via the opening.

15. The filter assembly of claim 14, wherein the filter comprises exactly three layers.

16. The filter assembly of claim 14, wherein one layer is configured for insertion into the pocket via the opening.

17. The filter assembly of claim 14, wherein more than one layer is configured for insertion into the pocket via the opening.

18. The filter assembly of claim 14, wherein the filter comprises first, second, and third layers,
wherein the second layer is dispersed between the first layer and the third layer, and
wherein the second layer is configured for insertion into the pocket via the opening.

19. The filter assembly of claim 14, further comprising an attachment member proximate to the common edge of the filter.

20. The filter assembly of claim 14, wherein one or more layers has a perforation adjacent to the common edge that runs in a direction parallel to the common edge.
